(19) United States
(12) Patent Application Publication
(10) Pub. No.: US 2015/0040031 A1
(43) Pub. Date: Feb. 5, 2015

(54) METHOD AND ELECTRONIC DEVICE FOR SHARING IMAGE CARD

(71) Applicant: Samsung Electronics Co., Ltd., Suwon-si (KR)

(72) Inventors: Hye-won LEE, Anyang-si (KR); Yoon-su KIM, Seoul (KR); Jung Joo SOHN, Seoul (KR); Keum-koo LEE, Yongin-si (KR); Young-kyu JIN, Seoul (KR)

(73) Assignee: SAMSUNG ELECTRONICS CO., LTD., Suwon-si (KR)

(21) Appl. No.: 14/449,565

(22) Filed: Aug. 1, 2014

(30) Foreign Application Priority Data
Aug. 1, 2013 (KR) 10-2013-0091585

(51) Int. Cl. G06F 3/0484; G06F 17/30; G06F 13/36

(52) U.S. Cl. CPC G06F 3/04842; G06F 13/36; G06F 17/30277
USPC 715/748

(57) ABSTRACT

Provided is a method of sharing an image card with an external device. The method includes receiving, at the electronic device, a user input, obtaining at least one image associated with content that is provided by the electronic device, according to the user input, generating a first image card comprising the at least one image, based on preset template information, and sharing the first image card to the external device.

### CROSS-REFERENCE TO RELATED APPLICATION

This application claims priority from Korean Patent Application No. 10-2013-0091585, filed on Aug. 1, 2013, in the Korean Intellectual Property Office, the disclosure of which is incorporated herein by reference in its entirety.

### BACKGROUND

1. Technical Field

Systems, methods, and apparatuses consistent with exemplary embodiments relate to a method and electronic device for sharing an image card with an external device.

2. Description of the Related Art

Along with an increase in the number of smart phone users, the number of users who use social networking services (SNS) has also experienced an increase many of which access these SNS using their smart phones. An SNS may be described as a service by which a user may build a relationship network with other users online. Users may build a new network or may strengthen relationships within existing networks using the SNS.

However, some users who do not use smart phones or are not good at manipulating smart phones may experience some difficulty in accessing the SNS.

Thus, there is a demand for a system that allows the SNS to be useable so users may conveniently and easily express their situations.

### SUMMARY

One or more exemplary embodiments provide a method and electronic device for sharing an image card with an external device, whereby the image card associated with content that is provided by the electronic device may be generated via a simple user input, and may be shared with the external device.

According to an aspect of an exemplary embodiment, there is provided a method of sharing an image card with an external device performed by an electronic device, the method including receiving, at the electronic device, a user input, obtaining at least one image associated with content that is provided by the electronic device, according to the user input, generating a first image card including the at least one image, based on preset template information, and sharing the first image card to the external device.

The receiving of the user input may include receiving as the user input a selection of a preset button that corresponds to at least one of an image collecting request and an image card generating request.

The obtaining of the at least one image may include obtaining metadata about the content, and searching for the at least one image associated with the content, by using the metadata.

The obtaining of the at least one image may include obtaining context information in response to receiving the user input, and obtaining the at least one image associated with the content, based on at least the context information.

The context information may include at least one of location information about the electronic device, status information about a user of the electronic device, environment information within a predetermined distance from the electronic device, and user's schedule information.

The preset template information may include at least one of layout information, theme information, text design information, and information about an effect filter that transforms an image into a different form.

The generating of the first image card may include generating image cards by using templates included in the preset template information, displaying a list of the image cards, and receiving an input selecting one image card from the list, as the first image card.

The generating of the first image card may include inserting link information related to the content into the first image card.

The sharing the first image card may include receiving an input of a text related to the first image card, adding the text to the first image card, and sharing the first image card having the text added thereto to the external device.

The method may further include displaying, on a screen, a list of first image cards including the first image card and one or more first image cards that were previously generated.

The method may further include receiving a second image card generated by the external device, and displaying the second image card.

The receiving of the second image card may include sharing, to a server, an image card recommendation request including at least one of attribute information about the first image card and context information that is obtained by the electronic device according to the user input, and receiving, from the server, the second image card that is selected as a recommended image card based on at least one of the attribute information about the first image card and the context information.

The receiving of the second image card may include sharing, to a server, an image card recommendation request including location information about the electronic device, and receiving, from the server and based on the location information about the electronic device, second image cards that are generated by external devices, respectively, that are located within a predetermined distance from the electronic device, and wherein the displaying of the second image card includes displaying, on a screen, a list of the second image cards that are generated by the external devices.

The receiving of the second image card may include receiving second image cards generated by the external device, and wherein the displaying of the second image card may include displaying, on a screen, a list of the second image cards based on information about reception times at which the second image cards were received.

The displaying of the second image card may include adding the second image card to user profile information that corresponds to the external device, and displaying the user profile information including the second image card.

The displaying of the second image card may include displaying the second image card on a lock screen.

The displaying of the second image card may include receiving an incoming call request from the external device, and displaying the second image card on an incoming call receiving screen, according to the incoming call request.

The displaying of the second image card may include adding the second image card to at least one of a photo album, a diary, a calendar, a map, a content reproduction list, and a phone address book that are provided by the electronic device, and displaying the second image card.

According to an aspect of another exemplary embodiment, there is provided an electronic device including a user input unit configured to receive a user input, a controller configured to obtain at least one image associated with content that is provided by the electronic device, according to the user input, and generate a first image card including the at least one image, based on preset template information, and a communication unit configured to share the first image card to an external device.

The user input unit may be further configured to receive as the user input a selection a preset button that corresponds to at least one of an image collecting request and an image card generating request.

The controller may be further configured to obtain metadata about the content, and search for the at least one image associated with the content, by using the metadata.

The controller may be further configured to obtain context information in response to receiving the user input, and obtain the at least one image associated with the content, based on at least the context information.

The controller may be further configured to generate image cards by using templates included in the preset template information, and display a list of the image cards, and wherein the user input unit is further configured to receive an input selecting one image card from the list, as the first image card.

The controller may be further configured to insert link information related to the content into the first image card.

The user input unit may be further configured to receive an input of a text related to the first image card, wherein the controller is further configured to add the text to the first image card, and wherein the communication unit is further configured to share the first image card having the text added thereto to the external device.

The electronic device may further include a display unit configured to display, on a screen, a list of first image cards including the first image card and one or more first image cards that were previously generated.

The communication unit may be further configured to receive a second image card generated by the external device, and wherein the electronic device may further include a display unit configured to display the second image card.

The communication unit may be further configured to transmit, to a server, an image card recommendation request including at least one of attribute information about the first image card and context information that is obtained by the electronic device according to the user input, and receive, from the server, the second image card that is selected as a recommended image card based on at least one of the attribute information about the first image card and the context information.

The communication unit may be further configured to transmit, to a server, an image card recommendation request including location information about the electronic device, and receive, from the server and based on the location information about the electronic device, second image cards that are generated by external devices, respectively, that are located within a predetermined distance from the electronic device, and wherein the display unit may be further configured to display, on a screen, a list of the second image cards that are generated by the external devices.

The communication unit may be further configured to receive second image cards generated by the external device, and wherein the display unit may be further configured to display, on a screen, a list of the second image cards based on information about reception times at which the second image cards were received.

The controller may be further configured to add the second image card to user profile information that corresponds to the external device, and wherein the display unit may be further configured to display the user profile information including the second image card.

The display unit may be further configured to display the second image card on a lock screen.

The communication unit may be further configured to receive an incoming call request from the external device, and wherein the display unit may be further configured to display the second image card on an incoming call receiving screen, according to the incoming call request.

The display unit may be further configured to add the second image card to at least one of a photo album, a diary, a calendar, a map, a content reproduction list, and a phone address book that are provided by the electronic device, and display the second image card.

A non-transitory computer-readable recording medium may have recorded thereon a program for executing a method, by using a computer.

Additional aspects will be set forth in part in the description which follows and, in part, will be apparent from the description, or may be learned by practice of the presented embodiments.

### BRIEF DESCRIPTION OF THE DRAWINGS

These and/or other aspects will become apparent and more readily appreciated from the following description of exemplary embodiments, taken in conjunction with the accompanying drawings in which:

FIG. 1 is a block diagram of an image card sharing system according to an exemplary embodiment;

FIG. 2 is a flowchart of a method of sharing an image card, according to an exemplary embodiment;

FIG. 3 illustrates an example in which at least one image is obtained, according to an exemplary embodiment;

FIG. 4 illustrates template information, according to an exemplary embodiment;

FIG. 5 illustrates image cards that are generated by an electronic device by applying an image to templates, according to an exemplary embodiment;

FIG. 6 illustrates a plurality of image cards that are generated by the electronic device by applying a plurality of images to a plurality of templates, according to an exemplary embodiment;

FIG. 7 illustrates various image cards, according to an exemplary embodiment;

FIG. 8 illustrates a list of first image cards, according to an exemplary embodiment;

FIG. 9 is a flowchart of a method of sharing an image card between the electronic device and an external device, according to an exemplary embodiment;

FIG. 10 illustrates an example in which the electronic device shares an image card with external devices included in a friend list, via a server, according to an exemplary embodiment;

FIG. 11 illustrates an example of a screen on which the external device displays a first image card received from the electronic device, according to an exemplary embodiment;

FIG. 12 illustrates an example in which the electronic device shares a first image card with the external device via a message application, according to an exemplary embodiment;

FIG. 13 illustrates an example in which the electronic device collects a second image card generated by the external device, according to an exemplary embodiment;

FIG. 14 is a flowchart of a method of sharing a first image card with a particular sharing target, the method performed by the electronic device, according to an exemplary embodiment;

FIG. 15 illustrates an example in which the electronic device receives a user input requesting generation of an image card while the electronic device executes a calendar application, according to an exemplary embodiment;

FIG. 16 illustrates an example of an image card that is associated with schedule information and is generated by the electronic device, according to an exemplary embodiment;

FIGS. 17A and 17B illustrate examples of a setting window for setting a sharing target, according to an exemplary embodiment;

FIG. 18 illustrates an example in which the external device that has the same schedule information as the electronic device displays a first image card received from the electronic device, according to an exemplary embodiment;

FIG. 19 is a flowchart of a method of displaying a recommended image card, the method performed by the electronic device, according to an exemplary embodiment;

FIGS. 20A and 20B illustrate an example in which the electronic device co-displays a first image card generated by the electronic device, and a recommended image card, according to an exemplary embodiment;

FIG. 21 illustrates an example in which the electronic device recommends an image card of another person, based on a generation location of the image card, according to an exemplary embodiment;

FIG. 22 illustrates an example of a list of second image cards that are generated by external devices, respectively, that are located within a predetermined distance from the electronic device, according to an exemplary embodiment;

FIG. 23 illustrates an incoming call receiving screen on which a second image card is displayed, according to an exemplary embodiment;

FIG. 24 illustrates an example in which a second image card is displayed on a phone book, according to an exemplary embodiment;

FIG. 25 illustrates an example in which a second image card is displayed on a lock screen, according to an exemplary embodiment;

FIG. 26 illustrates an example in which a first image card is used as a signature for an email, according to an exemplary embodiment; and

FIGS. 27 and 28 are block diagrams of the electronic device, according to exemplary embodiments.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing steps and/or operations described is an example; however, the sequence of and/or operations is not limited to that set forth herein and may be changed as is known in the art, with the exception of steps and/or operations necessarily occurring in a particular order. In addition, respective descriptions of well-known functions and constructions may be omitted for increased clarity and conciseness.

Additionally, exemplary embodiments will now be described more fully hereinafter with reference to the accompanying drawings. The exemplary embodiments may, however, be embodied in many different forms and should not be construed as being limited to the embodiments set forth herein. These embodiments are provided so that this disclosure will be thorough and complete and will fully convey the exemplary embodiments to those of ordinary skill in the art. The scope is defined not by the detailed description but by the appended claims. Like numerals denote like elements throughout.

All terms including descriptive or technical terms which are used herein should be construed as having meanings that are obvious to one of ordinary skill in the art. However, the terms may have different meanings according to an intention of one of ordinary skill in the art, precedent cases, or the appearance of new technologies. Also, some terms may be arbitrarily selected by the applicant, and in this case, the meaning of the selected terms will be described in detail in the detailed description. Thus, the terms used herein have to be defined based on the meaning of the terms together with the description throughout the specification.

Also, when a part “includes” or “comprises” an element, unless there is a particular description contrary thereto, the part can further include other elements, not excluding the other elements. In the following description, terms such as “unit” and “module” indicate a unit for processing at least one function or operation, wherein the unit and the block may be embodied as hardware or software or embodied by combining hardware and software.

The term “ . . . unit” used in the embodiments indicates a component including software or hardware, such as a Field Programmable Gate Array (FPGA) or an Application-Specific Integrated Circuit (ASIC), and the “ . . . unit” performs certain roles. However, the “ . . . unit” is not limited to software or hardware. The “ . . . unit” may be configured to be included in an addressable storage medium or to reproduce one or more processors. Therefore, for example, the “ . . . unit” includes components, such as software components, object-oriented software components, class components, and task components, processes, functions, attributes, procedures, subroutines, segments of program code, drivers, firmware, microcode, circuits, data, a database, data structures, tables, arrays, and variables. A function provided inside components and “ . . . units” may be combined into a smaller number of components and “ . . . units”, or further divided into additional components and “ . . . units”.

One or more exemplary embodiments will now be described more fully with reference to the accompanying drawings. However, the one or more exemplary embodiments may be embodied in many different forms, and should not be construed as being limited to the exemplary embodiments set forth herein; rather, these exemplary embodiments are provided so that this disclosure will be thorough and complete, and will fully convey the concept of the one or more exemplary embodiments to those of ordinary skill in the art. In the following description, well-known functions or constructions are not described in detail because they would obscure the one or more exemplary embodiments with unnecessary detail, and like reference numerals in the drawings denote like or similar elements throughout the specification.

As used herein, the term “and/or” includes any and all combinations of one or more of the associated listed items. Expressions such as “at least one of,” when preceding a list of elements, modify the entire list of elements and do not modify the individual elements of the list.

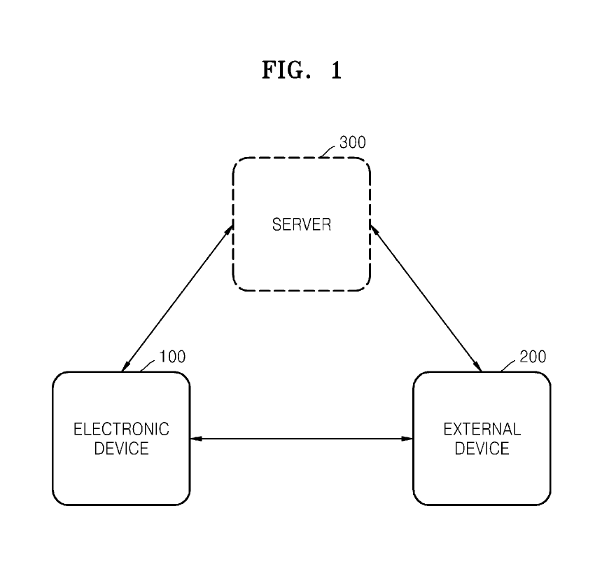

FIG. 1 is a block diagram of an image card sharing system according to an exemplary embodiment.

As illustrated in FIG. 1, the image card sharing system may include an electronic device 100, an external device 200, and a server 300. However, not all shown elements are necessary elements. That is, the image card sharing system may be embodied with more or less elements than the shown elements. For example, in other examples, the server 300 may be or may not be included in the image card sharing system.

Hereinafter, each of the elements will be described.

The electronic device 100 may generate an image card, according to a user input. Also, the electronic device 100 may share an image card with the external device 200 via wired or wireless communication. For example, the electronic device 100 may transmit a first image card generated by the electronic device 100 to the external device 200, and may receive a second image card generated by the external device 200 from the external device 200. Throughout the specification, the transmission of the first image card may include transmitting first image card information (e.g., information about at least one image that configures the first image card, link information, template information, or the like). Also, throughout the specification, the reception of the second image card may include receiving second image card information (e.g., information about at least one image that configures the second image card, link information, template information, or the like).

In the present exemplary embodiment, the image card may include at least one image associated with content that is provided by the electronic device 100. Throughout the specification, the term “content” means digital information that is provided via a wired or wireless communication network. In one or more exemplary embodiments, the content may include, but is not limited to, moving picture content (e.g., a video-on-demand (VOD) TV program video, a personal video such as User-Created Contents (UCC), a music video, a YouTube video, etc.), still image content (e.g., a photo, a picture, etc.), text content (e.g., an electronic book (poetry, novels, etc.), a letter, a work file, etc.), music content (e.g., music, radio broadcasting, etc.), a web page, application execution information, or the like.

Throughout the specification, the term “application” means a group of computer programs designed to perform a particular work. The application described in the present application may vary. For example, the application may include, but is not limited to, a game application, a video reproducing application, a map application, a memo application, a calendar application, a phone book application, a broadcasting application, an exercise support application, a payment application, a photo folder application, or the like.

According to one or more exemplary embodiment, sharing a first image card with an external device may included transmitting at least the first image card to the external device directly. According to another exemplary embodiment, sharing may include transmitting the first image card to an intermediary device, such as a server, which then provides the first image card to the external device. Further, according to yet another exemplary embodiment, sharing may include providing a pointer to the external device which provides the external device with information as to where to find the first image card, such as a specific address on a server where the first image card is stored.

In the present exemplary embodiment, the image card may include at least one image that is obtained in consideration of context information collected by the electronic device 100.

In the present exemplary embodiment, the context information may include, but is not limited to, at least one of surrounding environment information about the electronic device 100, status information about the electronic device 100, user's status information, and user's schedule information.

The surrounding environment information about the electronic device 100 means environment information within a predetermined range from the electronic device 100, and for example, may include weather information, temperature information, humidity information, illuminance information, noise information, and sound information, but one or more exemplary embodiments are not limited thereto.

The status information about the electronic device 100 may include, but is not limited to, information about modes of the electronic device 100 (e.g., a sound mode, a vibration mode, a mute mode, an energy saving mode, a blocking mode, a multi-window mode, an automatic rotation mode, etc.), location information and time information about the electronic device 100, communication module activation information (e.g., Wi-Fi ON/Bluetooth OFF/global positioning system (GPS) ON/near field communication (NFC) ON, etc.), network access status information about the electronic device 100, information about an application that is executed by the electronic device 100 (e.g., identifier (ID) information of the application, a type of the application, a use time of the application, a use period of the application, etc.).

The user's status information may include, but is not limited to, information about a motion of a user, a living pattern of the user, etc., in more detail, information about a user' status when the user walks, exercises, drives a car, sleeps, etc., information about a user's mood, etc.

In the present exemplary embodiment, the image card may be embodied in various forms. For example, the image card may be in the form of at least one of a post card, a name card, an invitation card, and a gift card, but one or more exemplary embodiments are not limited thereto. Hereinafter, for convenience of description, it is assumed that an image card that is generated by the electronic device 100 is a first image card, and an image card that is generated by the external device 200 is a second image card.

In the present exemplary embodiment, the user input may include, but is not limited to, at least one of a touch input, a bending input, a voice input, a key input, and a multimodal input.

Throughout the specification, the term “touch input” indicates a gesture of the user which is performed on a touch screen so as to control the electronic device 100. For example, the touch input may include a tap gesture, a touch & hold gesture, a double tap gesture, a drag gesture, a panning gesture, a flick gesture, a drag & drop gesture, or the like.

“Tapping” is a user's motion of touching a screen by using a finger or a touch tool (e.g., an electronic pen) and then instantly lifting the finger or touch tool from the screen.

“Touching & holding” is a user's motion of touching a screen by using a finger or a touch tool (e.g., an electronic pen) and then maintaining the above touching motion for a critical time (e.g., 2 seconds) or longer, after touching the screen. For example, a time difference between a touch-in time and a touch-out time is greater than or equal to the critical time (e.g., 2 seconds). When a touch input lasts more than the critical time, in order to inform the user whether the touch input is tapping or touching & holding, a feedback signal may be provided in a visual, acoustic, or tactile manner. In other exemplary embodiments, the critical time may vary.

“Double tapping” is a user's motion of rapidly touching the screen twice by using a finger or touch tool (such as an electronic pen).

“Dragging” is a user's motion of touching a screen by using the finger or touch tool and moving the finger or touch tool to another position on the screen while keeping the touching motion. The dragging motion may enable the moving or panning motion of an object.

“Panning” is a user's motion of performing a dragging motion without selecting an object. Because no object is selected in the panning motion, no object is moved in a page but the page itself is moved on the screen or a group of objects may be moved within a page.

“Flicking” is a user's motion of rapidly performing a dragging motion over a critical speed (e.g., 100 pixel/s) by using the finger or touch tool. The dragging (panning) motion or the flicking motion may be distinguished based on whether a moving speed of the finger or touch tool is over the critical speed (e.g., 100 pixel/s) or not.

“Dragging & Dropping” is a user's motion of dragging an object to a predetermined position on the screen with the finger or touch tool and then dropping the object at that position.

“Pinching” is a user's motion of moving two fingers touching the screen in opposite directions. The pinching motion is a gesture to magnify (open pinch) or contract (close pinch) an object or a page. A magnification value or a contraction value is determined according to the distance between the two fingers.

“Swiping” is a user's motion of touching an object on the screen with the finger or touch tool and simultaneously moving the object horizontally or vertically by a predetermined distance. A swiping motion in a diagonal direction may not be recognized as a swiping event.

Throughout the specification, the term “motion input” indicates a motion that a user does with the electronic device 100 so as to control the electronic device 100. For example, the motion input may include an input of the user who rotates the electronic device 100, tilts the electronic device 100, or moves the electronic device 100 in up and down-right and left directions. The electronic device 100 may sense a motion input that is preset by the user, by using an acceleration sensor, a tilt sensor, a gyro sensor, a 3-axis magnetic sensor, etc.

Throughout the specification, the term “bending input” indicates an input of a user who bends a whole or partial area of the electronic device 100 so as to control the electronic device 100, and here, the electronic device 100 may be a flexible display device. In the present exemplary embodiment, the electronic device 100 may sense a bending position (a coordinates-value), a bending direction, a bending angle, a bending speed, the number of times that the bending motion is performed, a time of occurrence of the bending motion, a hold time of the bending motion, etc.

Throughout the specification, the term “key input” indicates an input of a user who controls the electronic device 100 by using a physical key formed on the electronic device 100.

Throughout the specification, the term “multimodal input” indicates a combination of at least two input methods. For example, the electronic device 100 may receive a touch input and a motion input of the user, or may receive a touch input and a voice input of the user. Also, the electronic device 100 may receive a touch input and an eye input of the user. The eye input indicates an input by which the user adjusts a blinking motion of his or her eye, a gaze position, a moving speed of his or her eye, etc. so as to control the electronic device 100.

In the present exemplary embodiment, the electronic device 100 may be embodied in various forms. For example, the electronic device 100 may include, but is not limited to, a mobile phone, a smartphone, a laptop computer, a tablet personal computer (PC), an electronic book terminal, a digital broadcast terminal, a personal digital assistant (PDA), a portable multimedia player (PMP), a navigation device, an MP3 player, and a digital camera.

The external device 200 may receive the first image card generated by the electronic device 100, and may display the first image card on a screen of the external device 200. Also, the external device 200 may generate the second image card, in response to a user input, and may transmit the second image card to the external device 100.

In an exemplary embodiment, the external device 200 may receive the first image card from the electronic device 100 via the server 300, and may transmit the second image card to the electronic device 100 via the server 300. In another exemplary embodiment, the external device 200 may directly receive the first image card from the electronic device 100 or may directly send the second image card to the electronic device 100, without passing through the server 300.

The external device 200 may use the same image card sharing service as that used by the electronic device 100, but one or more exemplary embodiments are not limited thereto. The external device 200 may be connected with the electronic device 100 via an image card sharing service. Also, in the present exemplary embodiment, the external device 200 or a plurality of the external devices 200 may be provided.

The external device 200 may be embodied in various forms. For example, the external device 200 may include, but is not limited to, a mobile phone, a smartphone, a laptop computer, a tablet PC, an electronic book terminal, a digital broadcast terminal, a PDA, a PMP, a navigation device, an MP3 player, and a digital camera.

The server 300 may communication with the electronic device 100 or the external device 200. For example, the server 300 may receive the first image card generated by the electronic device 100 from the electronic device 100, and may receive the second image card generated by the external device 200 from the external device 200. Also, the server 300 may transmit the first image card to the external device 200, and may transmit the second image card to the electronic device 100.

The server 300 may receive sharing condition information from the electronic device 100 or the external device 200. The server 300 may share the first image card or the second image card with other devices, based on the sharing condition information.

The server 300 may manage an image card received from the electronic device 100 or the external device 200. The server 300 may manage the image card, according to a predetermined standard (e.g., according to devices, dates, or places).

The server 300 may store image cards in image card databases (DBs) according to devices, respectively. Then, the server 300 may update each of the image card DBs. The server 300 may update the image card DB according to a predetermined time period. The server 300 may update the image card DB when the server 300 receives a new image card from the electronic device 100 or the external device 200.

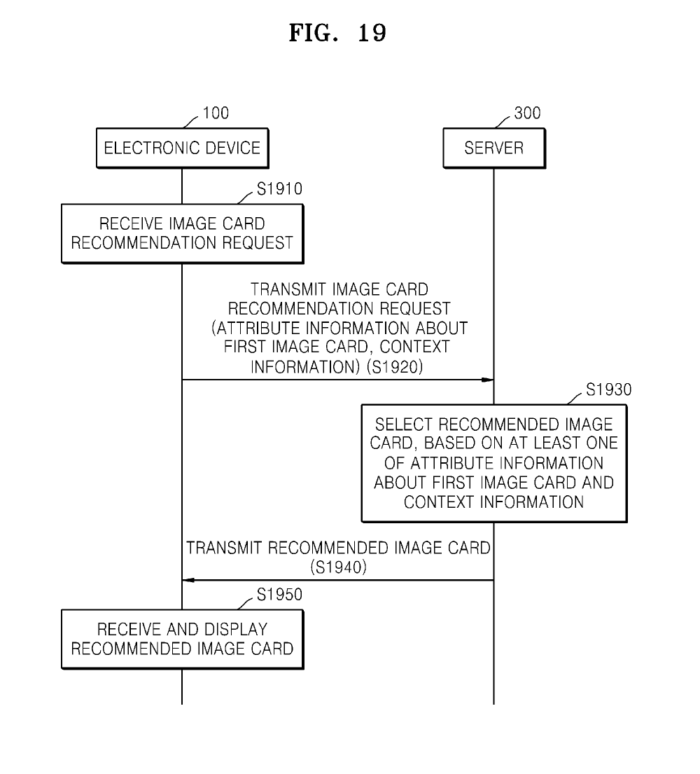

The server 300 may receive an image card recommendation request from the electronic device 100 or the external device 200. In response to the image card recommendation request, the server 300 may transmit a recommended image card to the electronic device 100 or the external device 200. The recommended image card will be described in detail with reference to FIG. 19.

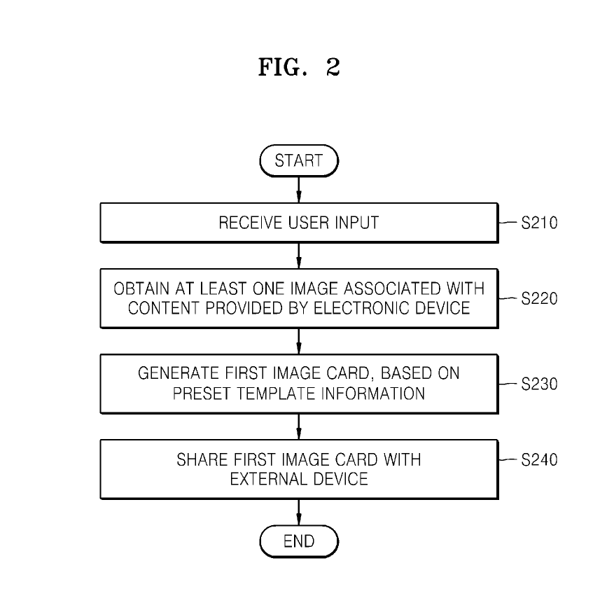

Hereinafter, an operation of generating a first image card according to a user input, and an operation of sharing the first image card with the external device 200, the operations performed by the electronic device 100, will now be described in detail with reference to FIG. 2.

FIG. 2 is a flowchart of a method of sharing an image card, according to an exemplary embodiment.

In operation S210, the electronic device 100 may receive a user input. Here, the user input may correspond to an image collecting request or an image card generating request. The user input may be in various forms, such as a key input, a touch input, a motion input, a bending input, a voice input, or a multimodal input. For convenience of description, it will be described according to an exemplary embodiment where the user input is in the form of the key input or the touch input.

The electronic device 100 may receive the user input that selects a preset button. The preset button may be a physical button formed on the electronic device 100 or may be a virtual button in the form of a Graphical User Interface (GUI).

For example, a user may co-select a first button (e.g., a home button) and a second button (e.g., a sound control button), and thus may transmit an image collecting request or an image card generating request to the electronic device 100.

In another exemplary embodiment, the electronic device 100 may display, on a screen of the electronic device 100, an UI object (e.g., a Pick icon) for the image collecting request or the image card generating request. Then, the electronic device 100 may receive the user's touch input with respect to the UI object (e.g., the Pick icon).

Hereinafter, according to an exemplary embodiment, a button for the image collecting request or the image card generating request is referred as a ‘Pick button’. The Pick button may be a physical button or a virtual button in GUI form.

In operation S220, the electronic device 100 may obtain at least one image associated with content that is provided by the electronic device 100, according to the user input (e.g., according to selection of the Pick button). Throughout the specification, the term “provide” may refer to reproduction, display, execution, etc.

The content that is provided by the electronic device 100 may include, but is not limited to, reproduced multimedia content (a moving picture, music, etc.), a webpage, a photo, a picture, a message, a calendar, schedule information, or folder information which is displayed on the screen, or an execution window of an executed application.

In the present exemplary embodiment, the electronic device 100 may receive metadata about content that is provided by the electronic device 100 when the electronic device 100 receives the user input (e.g., the selection of the Pick button). For example, the electronic device 100 may obtain metadata such as a title, a group, a genre, an artist, an amount of data, a stored date, a content provider, or the like about a reproduced music video, a title, a category, webpage related information, webpage visitor information, or the like of a displayed webpage, a name of an executed application, a category of the executed application, information about a user who has the same application, stored schedule information, or the like.

The electronic device 100 may search for the at least one image that is associated with the content, by using the obtained metadata. In the present exemplary embodiment, the electronic device 100 may search for the at least one image associated with the content, in a memory, by using the metadata.

In another exemplary embodiment, the electronic device 100 may perform a web search using the metadata. For example, the electronic device 100 may transmit the metadata to a web server (e.g., a search engine server) and may request a search with respect to the at least one image associated with the content. Then, the electronic device 100 may receive the at least one image associated with the content from the web server (e.g., the search engine server).

The electronic device 100 may obtain context information, according to the user input (e.g., the selection of the Pick button). For example, the electronic device 100 may receive the context information when the electronic device 100 receives the user input (e.g., the selection of the Pick button).

In the present exemplary embodiment, the context information may include, but is not limited to, at least one of location information about the electronic device 100, status information (e.g., motion information, mood information, health information, etc.) about a user of the electronic device 100, environment information (e.g., weather information, humidity information, temperature information, illuminance information, noise information, etc.) within a predetermined distance from the electronic device 100, and user's schedule information.

The electronic device 100 may collect the context information by using various sensors. For example, the electronic device 100 may obtain the location information about the electronic device 100 by using a GPS sensor, may obtain the status information about the user by using an acceleration sensor, a gyroscope sensor, a tilt sensor, a blood sugar sensor, etc., and may obtain the environment information by using a temperature sensor, a humidity sensor, an illuminance sensor, a microphone, etc.

The electronic device 100 may collect the context information by performing a web search. For example, the electronic device 100 may obtain weather information, temperature information, humidity information, etc. at a current location, by performing the web search.

The electronic device 100 may obtain the at least one image associated with the content, in consideration of the context information. For example, the electronic device 100 may obtain the at least one image by using the metadata and the context information about the content.

The electronic device 100 may obtain a preset number of images. For example, if the preset number is 3, the electronic device 100 may obtain three images. If 50 images are collected, the electronic device 100 may select three images from among the 50 images.

The electronic device 100 may obtain the preset number of images, based on user information (e.g., information about the number of times that an application is used, information about the number of times that a word is used, information about the number of times that a moving picture or music is reproduced, photo preference information, etc.) that has been accumulated since the purchase of the electronic device 100. Also, the electronic device 100 may group and select similar images.

The electronic device 100 may provide a list of collected images to the user, and may receive an input of selecting the preset number of images from the list.

In operation S230, the electronic device 100 may generate a first image card including the at least one image associated with the content that is provided by the electronic device 100, based on preset template information.

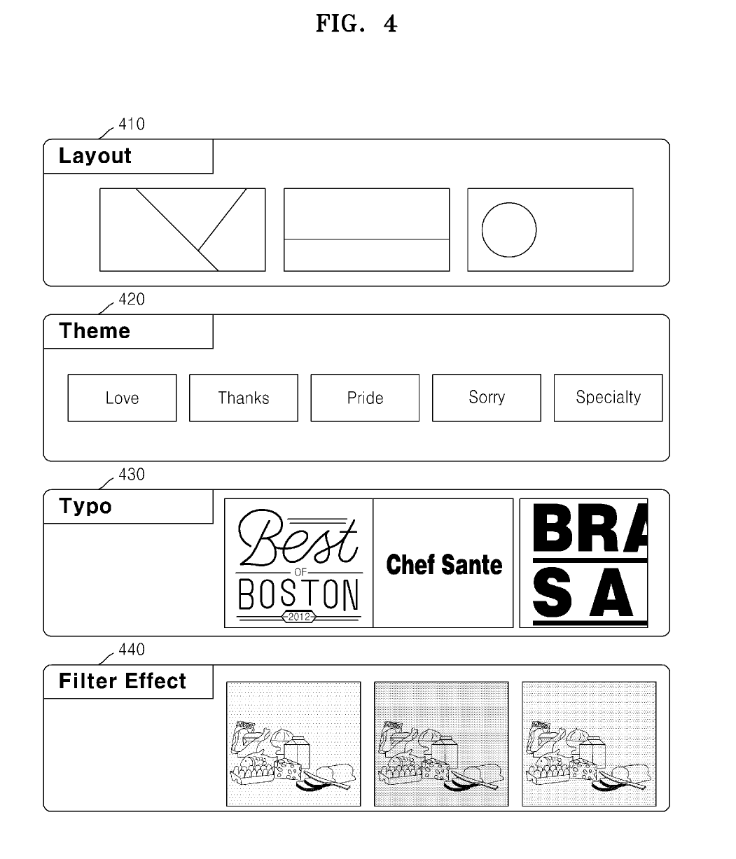

In the present exemplary embodiment, the preset template information is about at least one preset template, and for example, the preset template information may include, but is not limited to, at least one of layout information, theme information, text design information, and information about an effect filter that transforms an image into a different form. The template information will be described in detail with reference to FIG. 4.

The template may be set by the user or the electronic device 100 before the first image card is generated. For example, the user or the electronic device 100 may generate at least one template by combining a layout, a theme, a text design, and the effect filter. The preset template may be changed by the user or the electronic device 100.

The electronic device 100 may generate the first image card by applying the preset template to the at least one image. For example, the electronic device 100 may arrange the at least one image according to a layout, may add a theme image and a text design to the layout, may apply an effect filter (e.g., a black-and-white filter) thereto, and thus may generate a black-and-white first image card.

In the present exemplary embodiment, if preset templates are available, the electronic device 100 generates image cards by applying the preset templates, respectively, to the at least one image associated with the content. In this case, the electronic device 100 may display a list of the image cards, and may receive an input selecting, as the first image card, one image card from the list.

The electronic device 100 may select at least one template from among the preset templates, and may generate at least one first image card by using the at least one selected template. The electronic device 100 may select the at least one template from among the preset templates, based on characteristic information (e.g. a type (a person, a background, a thing, etc.) of an object included in an image, the number of images, or a purpose (e.g., an invitation, an advertisement, an alarm, etc.) to generate an image card) about the at least one image associated with the content. For example, if three person-centered images are obtained, the electronic device 100 may select a first template from among the preset templates. Then, the electronic device 100 may apply the three person-centered images to the first template and thus may generate the first image card.

The electronic device 100 may insert link information (e.g., a Uniform Resource Locator (URL)) associated with content. For example, the electronic device 100 may insert link information for a preview video, link information for a music file, link information of a website, etc. into the first image card.

The electronic device 100 may receive an input of a text related to the first image card. In this case, the electronic device 100 may change a text displayed on the first image card or may add the text.

In operation S240, the electronic device 100 may share the first image card with an external device. In the present exemplary embodiment, the electronic device 100 may share the first image card with the external device 200 in a Device to Device (D2D) manner or may share the first image card with the external device 200 via the server 300.

The electronic device 100 may receive an input from the user indicating a sharing condition. The sharing condition may include, but is not limited to, a condition about a sharing target, a condition about a sharing period, and a condition about a sharing area.

The electronic device 100 may transmit information about the sharing condition and the first image card to the server 300. Here, the server 300 may select the external device 200 that corresponds to the sharing condition, and then may transmit the first image card to the selected external device 200.

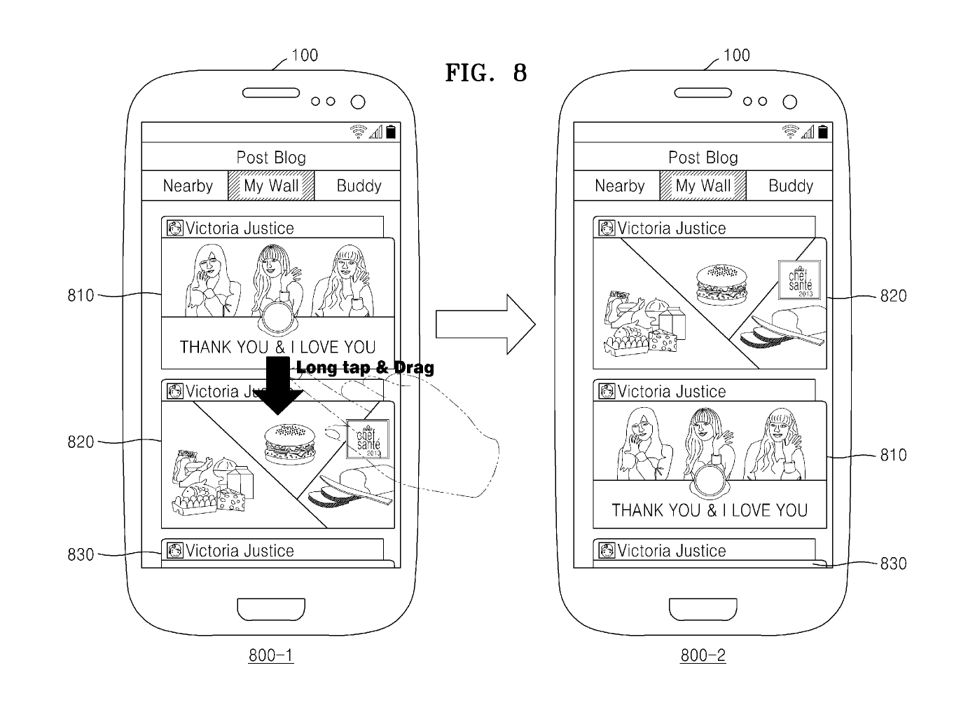

The electronic device 100 may display, on the screen, a list of first image cards that include the first image card generated according to the user input (e.g., the selection of the Pick button), and one or more previously-generated first image cards. The list of first image cards will be described in detail with reference to FIG. 8.

The electronic device 100 may perform operations S210 through S240, by using a particular application that provides the image card sharing service. In another exemplary embodiment, an order of operations S210 through S240 may be changed or some operations may be skipped.

The electronic device 100, in response to a user's simple input, may express a user's status (e.g., a location, a mood, a preference, etc.) or individuality as an image card, and may provide a new communication service that is shared with the external device 200.

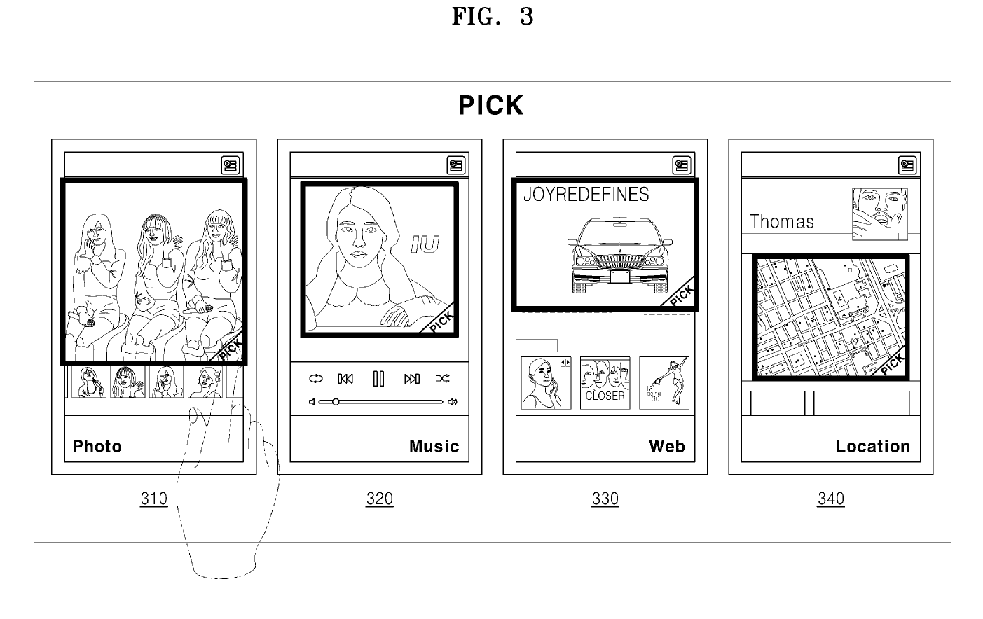

FIG. 3 illustrates an example in which at least one image is obtained, according to an exemplary embodiment.

As illustrated in 310, if a user selects a Pick button on an image while the user browses through a photo album, the electronic device 100 may collect at least one image associated with photo content that is currently displayed on a screen. For example, the electronic device 100 may obtain a first photo image that is currently displayed on the screen, a second photo image that includes persons in the currently-displayed first photo image, a third photo image that is found based on a location tag included in the photo content, or the like.

As illustrated in 320, if the user selects the Pick button while the user listens to music, the electronic device 100 may collect at least one image associated with music content that is currently being reproduced. For example, the electronic device 100 may obtain an album cover image, an artist image, or a music video image of the currently-reproduced music content, another album cover image of the same artist, or the like.

As illustrated in 330, if the user selects the Pick button while the user views a webpage, the electronic device 100 may collect at least one image associated with the currently-displayed webpage. For example, the electronic device 100 may obtain a representative image included in the webpage, an image associated with the representative image, an image related to a title of the webpage, or the like.

As illustrated in 340, if the user selects the Pick button while the user uses a map application, the electronic device 100 may collect at least one image associated with map content that is displayed on the screen. For example, the electronic device 100 may obtain a captured map image, an image (e.g., a restaurant image, a link image for accessing a website of an interest place) associated with the interest place (e.g., a point of interest (POI)), or the like.

FIG. 4 illustrates template information, according to an exemplary embodiment.

As described above, the template information may include at least one of layout information 410, theme information 420, text design information 430, and information about an effect filter 440 that transforms an image into a different form.

The layout information 410 indicates information about a layout and formation of images. As layout information 410, various layouts may be used according to the number of images, attributes of images, or the like. Particularly, three layouts are shown wherein a first layout includes two slanted lines that create the separation between areas in the layout, a second layout include a horizontal line, and a third layout includes a circle that creates the boundaries in the layout design.

The theme information 420 indicates information about an entire atmosphere or theme that makes up an image card. As illustrated in the theme information 420, various themes may be applied to the image card, according to a purpose of generating the image card. For example, the various themes may include Love, Thanks, Pride, Sorry, or the like.

The text design information 430 indicates information about a text and a design of the text included in an image card. For example, the text design information 430 may include information about a font type, a total number of words, a font size, a font color, or the like. As illustrated in the text design information 430, various text designs may be available.

The information about the effect filter 440 indicates information about a filter that transforms an image into a different form. For example, the effect filter 440 may include, but is not limited to, a night view effect filter, a blurring effect filter, a flare effect filter, a diffusion effect filter, a glow effect filter, a color effect filter, and a black-and-white effect filter. As illustrated in the effect filter 440, various effect filters may be applied to an image card.

According to the present exemplary embodiment, the electronic device 100 may select a layout from a layout list, may select a theme from a theme list, may select a text design from a text design list, and may select an effect filter from an effect filter list. Then, the electronic device 100 may generate various templates by combining the selected layout, theme, text design, and the effect filter.

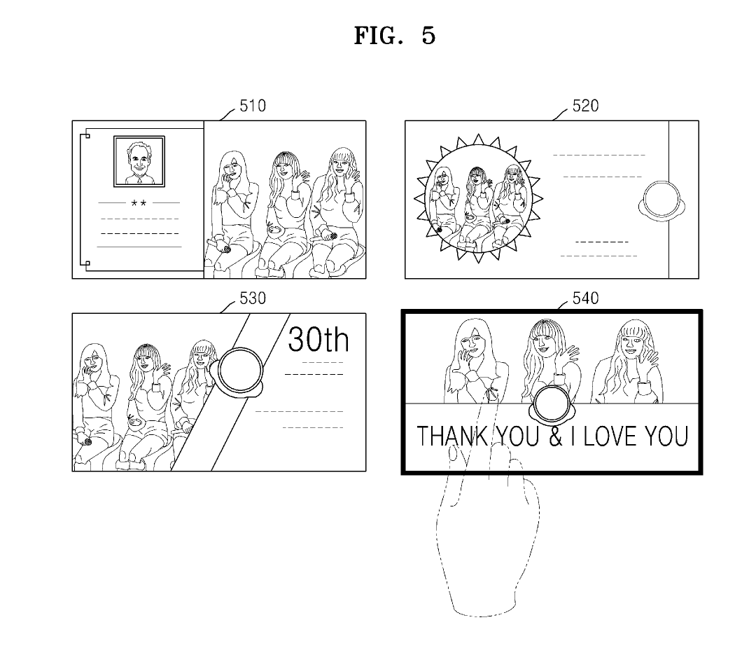

FIG. 5 illustrates image cards that are generated by the electronic device 100 by applying an image to templates, according to an exemplary embodiment. In the exemplary embodiment of FIG. 5, it is assumed that the electronic device 100 obtains at least one image shown in 310 of FIG. 3, and a plurality of preset templates are available.

As illustrated in FIG. 5, the electronic device 100 may use an image, which is obtained according to a user input (e.g., a selection of a Pick button), with each of the templates, and thus may generate image cards. For example, the electronic device 100 may apply a photo image to each of four templates, and thus may generate one or all of the four image cards 510, 520, 530, and 540.

The electronic device 100 may display the four image cards 510, 520, 530, and 540 on a screen, and may receive, from a user, an input selecting at least one image card as a first image card to be shared. For example, the user may select the image card 540 as the first image card.

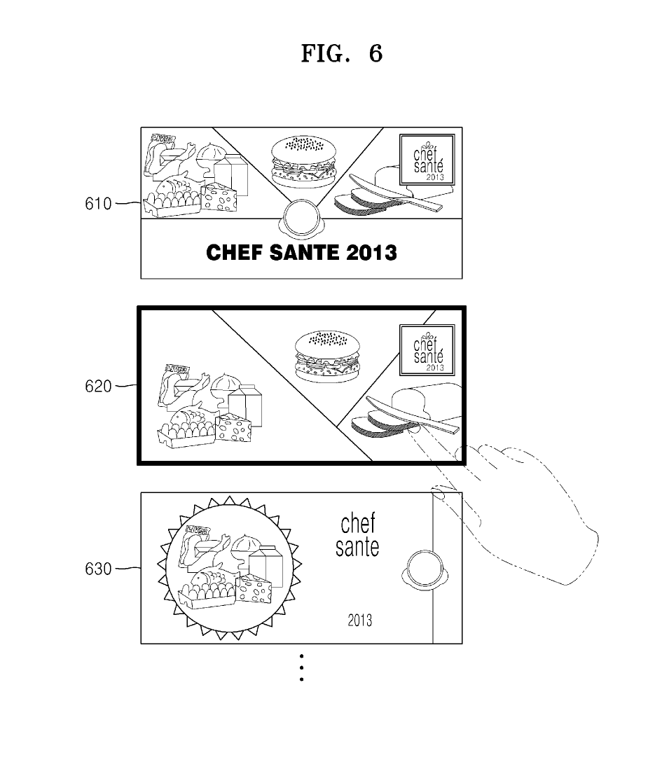

FIG. 6 illustrates a plurality of image cards that are generated by the electronic device 100 by applying a plurality of images to a plurality of templates, according to an exemplary embodiment.

As illustrated in FIG. 6, the electronic device 100 may obtain a plurality of images according to a user input (e.g., a selection of a Pick button), may apply the plurality of images to a plurality of templates, respectively, and thus may generate a plurality of image cards. For example, the electronic device 100 may apply three food photo images to three templates, respectively, and thus may generate three image cards 610, 620, and 630.

The electronic device 100 may display the three image cards 610, 620, and 630 on a screen, and may receive, from a user, an input selecting one image card as a first image card to be shared with the external device 200. For example, the user may select the image card 620 as the first image card.

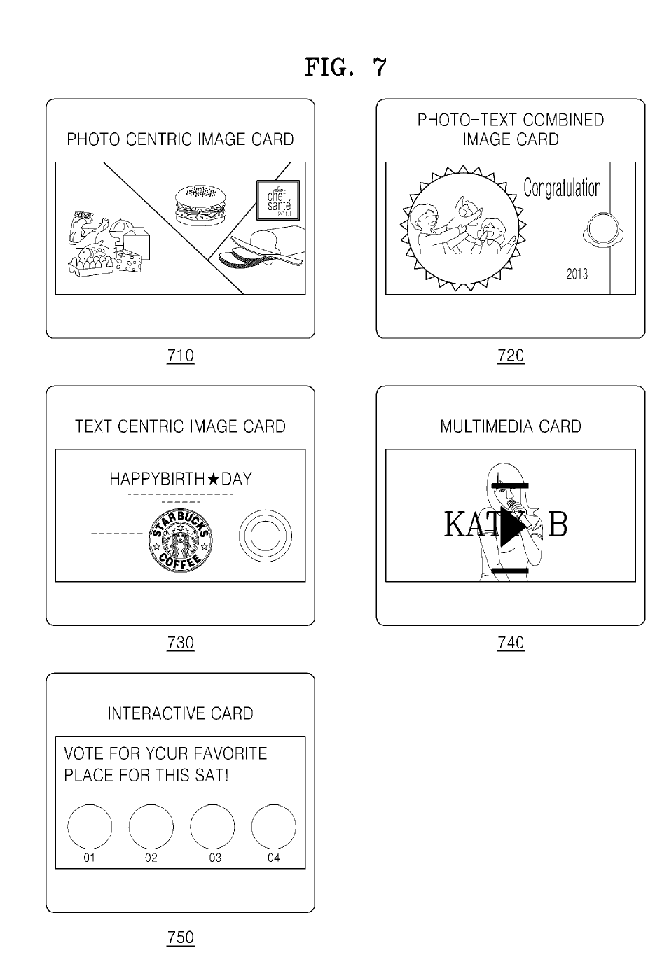

FIG. 7 illustrates various image cards, according to one or more exemplary embodiments.

As illustrated in 710, one of the image cards may be a photo-centered image card including only images.

As illustrated in 720, one of the image cards may be a photo-text combined image card.

As illustrated in 730, one of the image cards may be a text-centric image card. For example, the text-centric image card may include a store name, an image of a coupon issued by a store, or the like.

As illustrated in 740, one of the image cards may be a multimedia card that includes link information for enabling access to music or a moving picture.

As illustrated in 750, one of the image cards may be an interactive card for collecting comments, evaluations, preferences, or the like of users.

The electronic device 100 may generate an image card in various forms, and may share the image card in various forms with the external device 200.

FIG. 8 illustrates a list of first image cards, according to an exemplary embodiment.

As illustrated in 800-1, the electronic device 100 may display, on a screen, a list of first image cards that include a first image card generated according to a user input (e.g., a selection of a Pick button), and one or more previously-generated first image cards.

When the electronic device 100 receives an input of a swipe gesture in a vertical direction from a user, the electronic device 100 may scroll the list of the first image cards, according to the swipe gesture.

As illustrated in 800-2, when the electronic device 100 receives a user input by which a first image card 810 that is displayed in a first area is touched over a predetermined time and then is dragged, the electronic device 100 may move the first image card 810 displayed in the first area to a second area, and may move a first image card 820 that is displayed in the second area to the first area.

The electronic device 100 may delete a user-selected first image card from the list. Also, the electronic device 100 may differ in terms of access scopes of the first image cards, according to a user input. For example, according to the user input, the electronic device 100 may set an access scope of the first image card 810 displayed in the first area, as an open-to-friends scope, and may set an access scope of the first image card 820 displayed in the second area, as an open-to-limited-group scope.

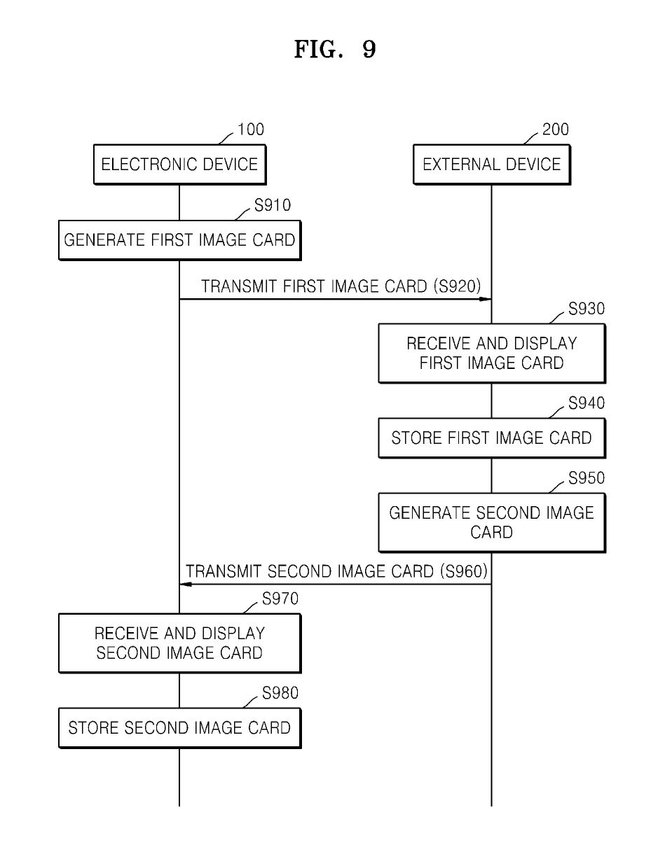

FIG. 9 is a flowchart of a method of sharing an image card between the electronic device 100 and the external device 200, according to an exemplary embodiment.

In operation S910, the electronic device 100 may generate a first image card. For example, the electronic device 100 may receive a user input (e.g., a selection of a Pick button), and may obtain at least one image associated with content that is provided by the electronic device 100, according to the user input (e.g., the selection of the Pick button). Then, the electronic device 100 may generate the first image card including the at least one image associated with the content that is provided by the electronic device 100, based on preset template information. Because operation S910 corresponds to operation S230 shown in FIG. 2, detailed descriptions thereof are omitted here.

In operation S920, the electronic device 100 may transmit the first image card to the external device 200. In the present exemplary embodiment, the electronic device 100 may transmit the first image card to the external device 200 via the server 300, or may directly transmit the first image card to the external device 200 via wireless or wired communication.

For example, the electronic device 100 may transmit the first image card to the external device 200 via short-distance communication (e.g., Bluetooth communication, wireless local area network (LAN), Wi-Fi Direct, NFC, ZigBee communication, etc.), or may transmit the first image card to the external device 200 via a mobile communication network or an internet network.

In operation S930, the external device 200 may receive the first image card and may display the first image card on a screen. For example, the external device 200 may display the first image card on at least one of a home screen, a lock screen, and an execution window of a predetermined application.

In operation S940, the external device 200 may store the first image card. The external device 200 may store the first image card in a content storage space that corresponds to at least one application associated with the first image card. For example, the external device 200 may store the first image card in a user profile storage space of a phone book, a registration space of a calendar, a photo storage space of a photo album, or the like.

In operation S950, the external device 200 may generate a second image card. For example, the external device 200 may receive a user input (e.g., a selection of a Pick button), and may obtain at least one image associated with content that is provided by the external device 200, according to the user input (e.g., the selection of the Pick button). Then, the external device 200 may generate the second image card including the at least one image associated with the content that is provided by the external device 200, based on preset template information. Because operations performed by the external device 200 to generate the second image card correspond to operations performed by the electronic device 100 to generate the first image card, detailed descriptions thereof are omitted here.

In operation S960, the external device 200 may transmit the second image card to the electronic device 100. In the present exemplary embodiment, the external device 200 may transmit the second image card to the electronic device 100 via the server 300 or may directly transmit the second image card to the electronic device 100 via wired or wireless communication.

For example, the external device 200 may transmit the second image card to the electronic device 100 via short-distance communication (e.g., Bluetooth communication, wireless LAN, Wi-Fi Direct, NFC, ZigBee communication, etc.), or may transmit the second image card to the electronic device 100 via a mobile communication network or an internet network.

In operation S970, the electronic device 100 may receive the second image card and may display the second image card on a screen. For example, the electronic device 100 may display the second image card on at least one of a home screen, a lock screen, and an execution window of a predetermined application.

The electronic device 100 may receive a plurality of second image cards from the external device 200, and may display a list of the second image cards on the screen. For example, the electronic device 100 may array the second image cards, based on information about reception times at which the second image cards were received, respectively. The recently-received second image cards may be positioned at a top of the list.

The electronic device 100 may provide only a predetermined number of second image cards from among the second image cards received from the external device 200. For example, the electronic device 100 may provide only five second image cards that have been recently received. In this case, the electronic device 100 may delete previously-received second image cards from a memory, and thus may efficiently manage the memory.

The electronic device 100 may display a second image card in connection with a profile of a friend who transmits the second image card via the external device 200. For example, if the electronic device 100 receives a second image card from a mobile phone of a friend AA, the electronic device 100 may display the second image card in an area where a profile image of the friend AA is displayed.

In the present exemplary embodiment, when the electronic device 100 receives an incoming call request from the external device 200, the electronic device 100 may display a second image card of the external device 200 on a call reception screen. Thus, the user may check an image card of a caller and thus may recognize an interest, a mood, recent conditions, etc. of the caller.

In operation S980, the electronic device 100 may store the second image card. For example, the electronic device 100 may add the second image card to user profile information that corresponds to the external device 200. Also, the electronic device 100 may add the second image card to at least one of a photo album, a diary, a calendar, a map, a content reproduction list, and a phone address book that are provided by the electronic device 100.

In another exemplary embodiment, an order of operations S910 through S980 may be changed or some operations may be skipped.

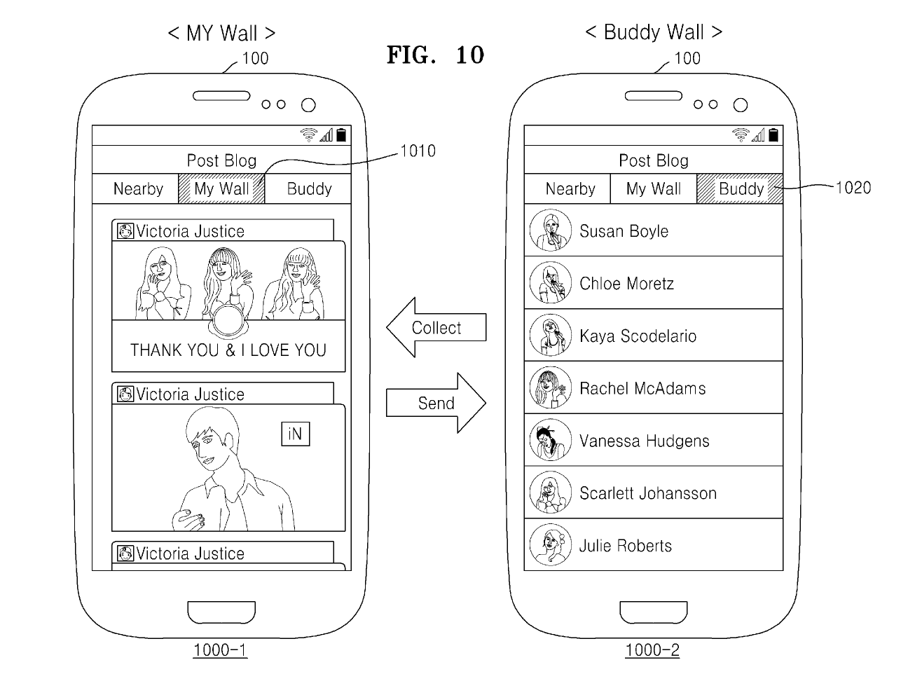

FIG. 10 illustrates an example in which the electronic device 100 shares an image card with external devices included in a friend list, via a server, according to an exemplary embodiment.

As illustrated in 1000-1, the electronic device 100 may transmit a first image card to devices of friends of a user of the electronic device 100. For example, when the first image card that is generated by the electronic device 100 is registered in a My Wall menu 1010, the electronic device 100 may transmit the first image card to the devices of the friends.

As illustrated in 1000-2, the electronic device 100 may receive second image cards, respectively, from the devices of the friends of the user of the electronic device 100, and may display a list of the second image cards on a screen. For example, when the user selects a Buddy menu 1020, the electronic device 100 may display a list of the friends on the screen. Here, if the user selects a friend from the list of the friends, the electronic device 100 may display a list of second image cards received from the selected friend, on the screen.

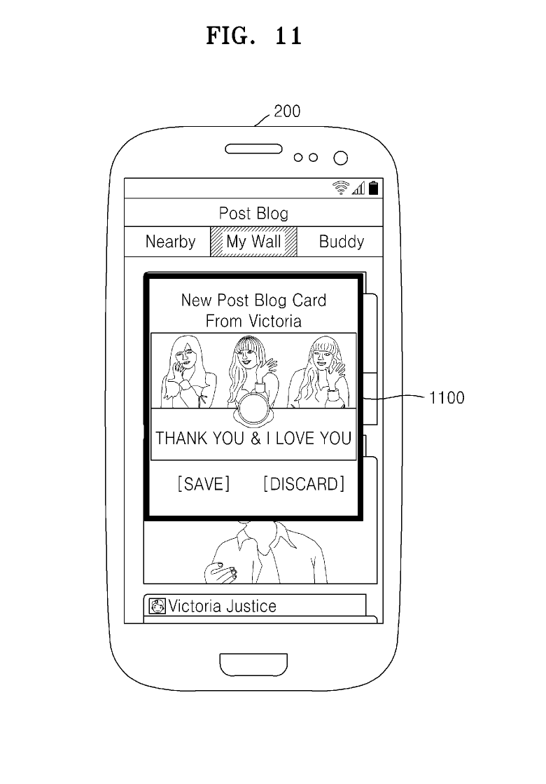

FIG. 11 illustrates an example of a screen on which the external device 200 displays a first image card received from the electronic device 100, according to an exemplary embodiment.

As illustrated in FIG. 11, when the external device 200 receives the first image card from the electronic device 100 (e.g., Victoria's phone), the external device 200 may display an alarm window 1100 including the first image card, a transmission body (from Victoria), etc. on a screen, and thus may inform a user of the external device 200 that a new first image card is received.

In the present exemplary embodiment, when a predetermined application (e.g., an application that provides an image card sharing service) is executed, the external device 200 may display the alarm window 1100 on an execution window of the predetermined application. Alternatively, the external device 200 may display the alarm window 1100 on a lock screen.

The external device 200 may display a GUI including SAVE and DISCARD items on the screen so as to ask the user whether or not to store the first image card. If the user selects the SAVE item, the external device 200 may map the first image card with ID information of the user (e.g., Victoria) of the electronic device 100 and may store the first image card and the ID information.

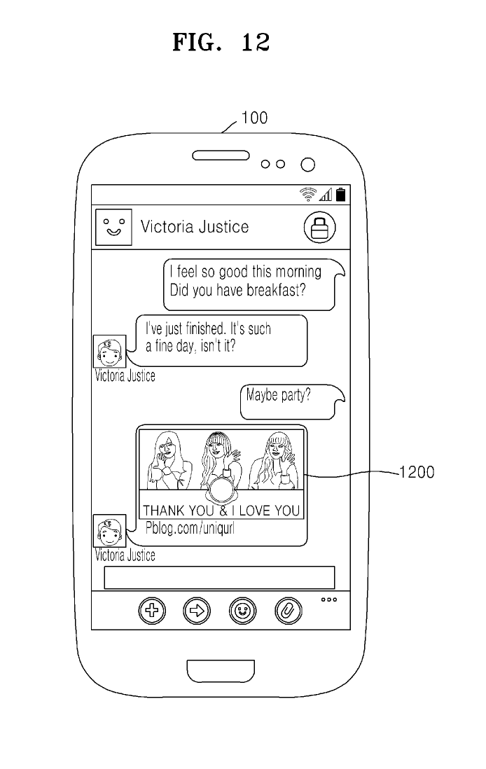

FIG. 12 illustrates an example in which the electronic device 100 shares a first image card with the external device 200 via a message application, according to an exemplary embodiment.

As illustrated in FIG. 12, the electronic device 100 may transmit the first image card to the external device 200 via a message application (e.g., a native communication application), a social communicator application (e.g., Kakao Talk, Band, MyPeople, etc.), or a social media application (e.g., Facebook, Twitter, etc.).

The electronic device 100 may capture the first image card and may transmit a captured first image card 1200 to the external device 200 via the message application. Thus, although an application that provides an image card sharing service is not installed in the external device 200, the electronic device 100 may share an image card with the external device 200 via the message application.

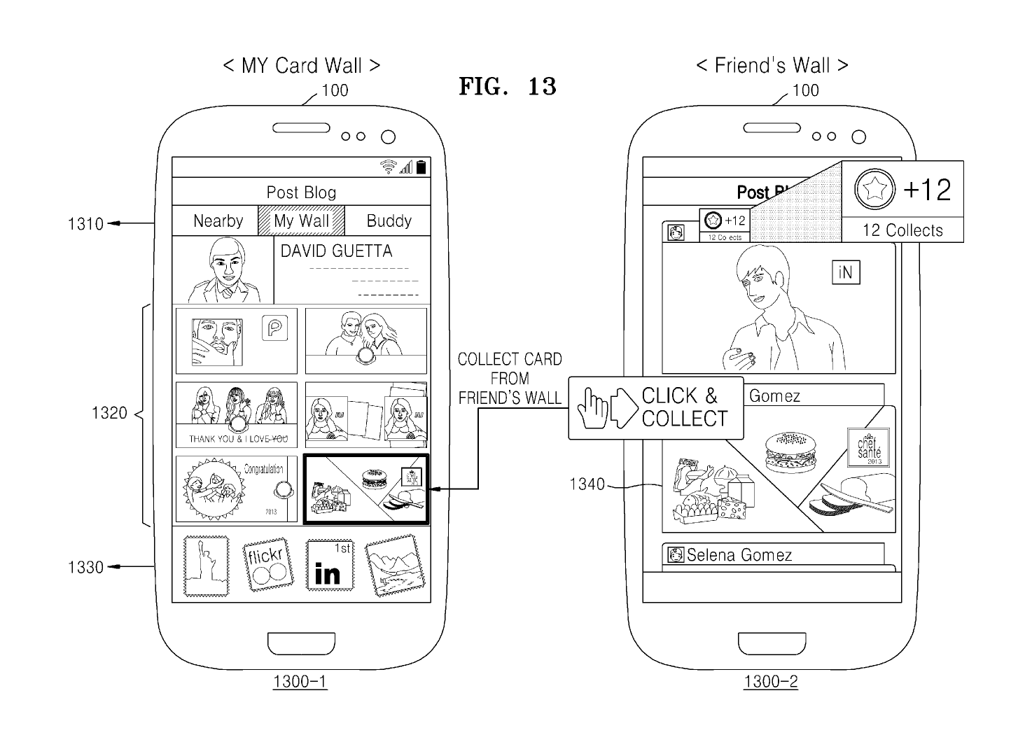

FIG. 13 illustrates an example in which the electronic device 100 collects a second image card generated by the external device 200, according to an exemplary embodiment.

As illustrated in 1300-1, the electronic device 100 may execute an application (hereinafter, referred as a ‘post blog application’) that provides an image card sharing service, and may display an execution window on a screen. The execution window of the post blog application may include, but is not limited to, a search menu 1310 including My Wall, Buddy, and Nearby items, an area 1320 where first image cards are displayed, and an area 1330 where stamps that are attachable to the first image cards are displayed.

As illustrated in 1300-2, the electronic device 100 may provide a post block screen including image cards of other persons. Here, when a user selects one of the image cards of other persons, the electronic device 100 may request and receive the selected image card of another person from a device of the other person or the server 300. Then, the electronic device 100 may add and display the received image card of the other person in the area 1320 where the first image cards are displayed.

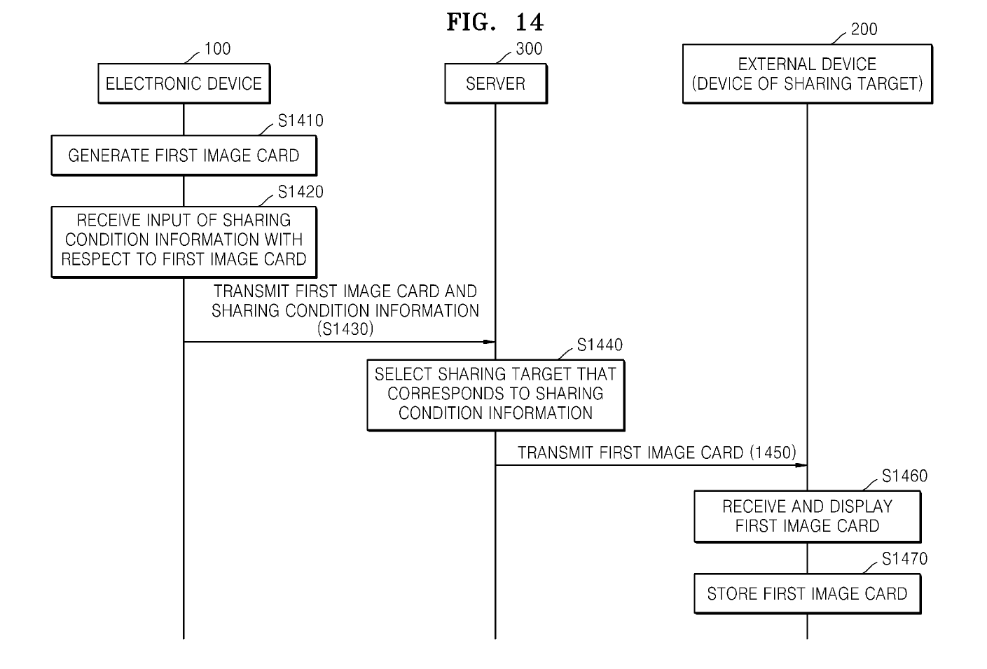

FIG. 14 is a flowchart of a method of sharing a first image card with a particular sharing target, the method performed by the electronic device 100, according to an exemplary embodiment.

In operation S1410, the electronic device 100 may generate a first image card. Because operation S1410 corresponds to operation S910 shown in FIG. 9, detailed descriptions thereof are omitted here.

In operation S1420, the electronic device 100 may receive an input of sharing condition information with respect to a first image card. The sharing condition information may indicate information about a target device (or a target friend) that a user of the electronic device 100 wants to share the first image card with. For example, the user may input a sharing condition by which a device of a friend having the same schedule, a device located within a predetermined distance from the electronic device 100, or the like are set as a sharing target device.

The user may directly specify a sharing target. For example, the user may input a sharing condition by which a friend AA, a friend BB, and a friend CC are set as the sharing target.

The sharing condition information may include sharing time period information. For example, the user may set a time period, by which the first image card is to be shared with the external device 200, as ‘one week’, ‘one month’, or a particular time period (From 25 July to 31 July).

In operation S1430, the electronic device 100 may transmit the first image card and the sharing condition information to the server 300. For example, the electronic device 100 may transmit, to the server 300, information about the first image card, and the sharing condition information about the sharing target to share the first image card.

In operation S1440, the server 300 may select the sharing target that corresponds to the sharing condition information.

For example, when the sharing condition information includes the friend AA, the friend BB, and the friend CC as the sharing target, the server 300 may select a device of the friend AA, a device of the friend BB, and a device of the friend CC as the external device 200 to receive the first image card.

In operation S1450, the server 300 may transmit the first image card to the external device 200 (e.g., a device of the sharing target). For example, when the device of the friend AA, the device of the friend BB, and the device of the friend CC are selected as the device of the sharing target that corresponds to the sharing condition information, the server 300 may transmit the first image card to each of the device of the friend AA, the device of the friend BB, and the device of the friend CC.

In operation S1460, the external device 200 (e.g., the device of the sharing target) may receive the first image card and may display the first image card on a screen. In operation S1470, the external device 200 (e.g., the device of the sharing target) may store the first image card. Because operations S1460 and S1470 correspond to operations S930 and S940 shown in FIG. 9, detailed descriptions thereof are omitted here.

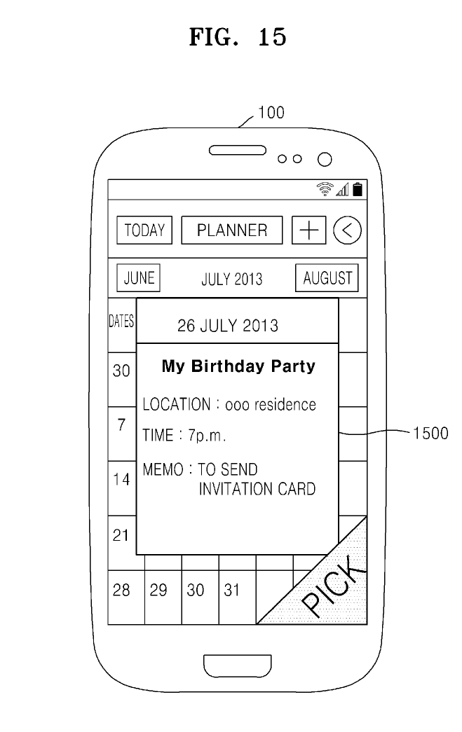

FIG. 15 illustrates an example in which the electronic device 100 receives a user input requesting generation of an image card while the electronic device 100 executes a calendar application, according to an exemplary embodiment.

As illustrated in FIG. 15, the electronic device 100 may execute the calendar application according to a user's request. Then, the electronic device 100 may display schedule information of 26 Jul., 2013 on a screen. Here, when a user selects a Pick button, the electronic device 100 may collect at least one image that corresponds to the schedule information.

For example, the electronic device 100 may analyze a text included in the schedule information and thus may extract words such as ‘birthday’, ‘OOO residence’, ‘invitation’, etc. The electronic device 100 may search for an image associated with the schedule information, by using the extracted words such as ‘birthday’, ‘OOO residence’, ‘invitation’, etc. The electronic device 100 may collect a map image in which a location of the OOO residence is marked, images of a flower, a cake, a present, etc. that are related to birthdays, an invitation card image, or the like.

The electronic device 100 may collect the at least one image by using context information at a point in time when the user selects the Pick button. For example, if rain falls when the user selects the Pick button, the electronic device 100 may collect an image associated with a rainy scene, or if snow falls when the user selects the Pick button, the electronic device 100 may collect an image of a snowman, or the like.

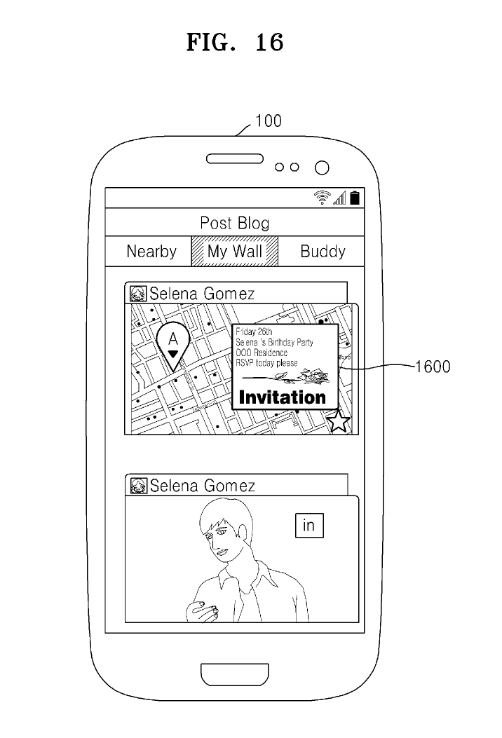

The electronic device 100 may apply the map image, the images of the flower, the cake, the present, etc. that are related to birthdays, the invitation card image, or the like to a preset template, and thus may generate a first image card. This will be described with reference to FIG. 16.

FIG. 16 illustrates an example of an image card that is associated with schedule information and is generated by the electronic device 100, according to an exemplary embodiment.

As illustrated in FIG. 16, the electronic device 100 may display a first image card 1600 that corresponds to the schedule information, on a screen. The first image card 1600 may be in an invitation card form in which an invitation card is displayed on a map image where a location of an OOO residence is marked. The invitation card may include a time (Friday 26th), a subject (Selena's Birthday Party), a place (OOO Residence), a response request (RSVP today please), etc.

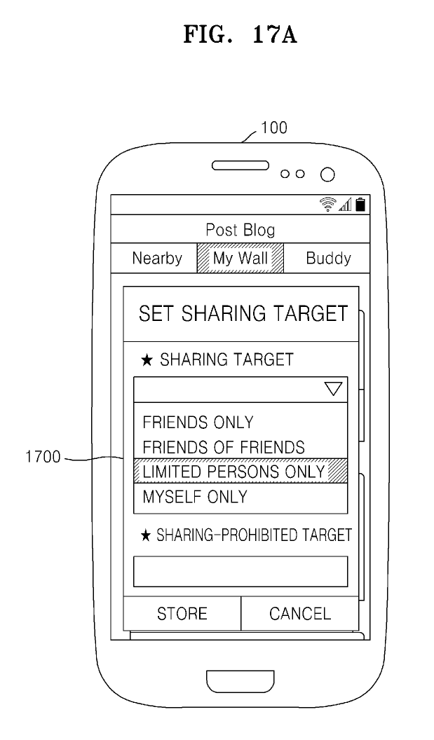

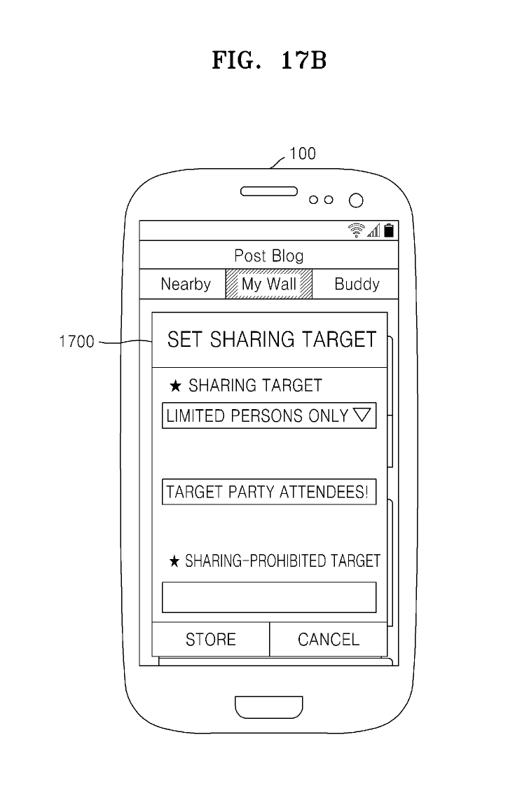

FIGS. 17A and 17B illustrate examples of a setting window for setting a sharing target, according to an exemplary embodiment.

As illustrated in FIG. 17A, the electronic device 100 may provide a selection window 1700 that enables selection of a sharing target to share the first image card 1600 that corresponds to schedule information. For example, the electronic device 100 may provide a selection window in which an item such as ‘friends only’, ‘friends of friends’, ‘limited persons only’, ‘myself only’, or the like may be selected as the sharing target.

As illustrated in FIG. 17B, the electronic device 100 may receive, from a user, an input of selecting a particular person as the sharing target. For example, the electronic device 100 may receive an input selecting ‘target party attendees’ as the sharing target. In this case, the electronic device 100 may transmit the first image card 1600 to the server 300 and may request the server 300 to transmit the first image card 1600 to the ‘target party attendees’.

The server 300 may collect a plurality of pieces of schedule information from a plurality of devices and may manage them. In this case, based on the plurality of pieces of schedule information collected from the plurality of devices, the server 300 may transmit the first image card 1600 to devices of friends having the same schedule (e.g., a plan to attend Selena's birthday party on Friday, 26 July) as the user of the electronic device 100. For example, if a friend AA, a friend BB, a friend CC, and a friend DD register schedules with respect to attending Selena's birthday party to their devices, respectively, the server 300 may transmit the first image card 1600 to the devices of the friend AA, the friend BB, the friend CC, and the friend DD.

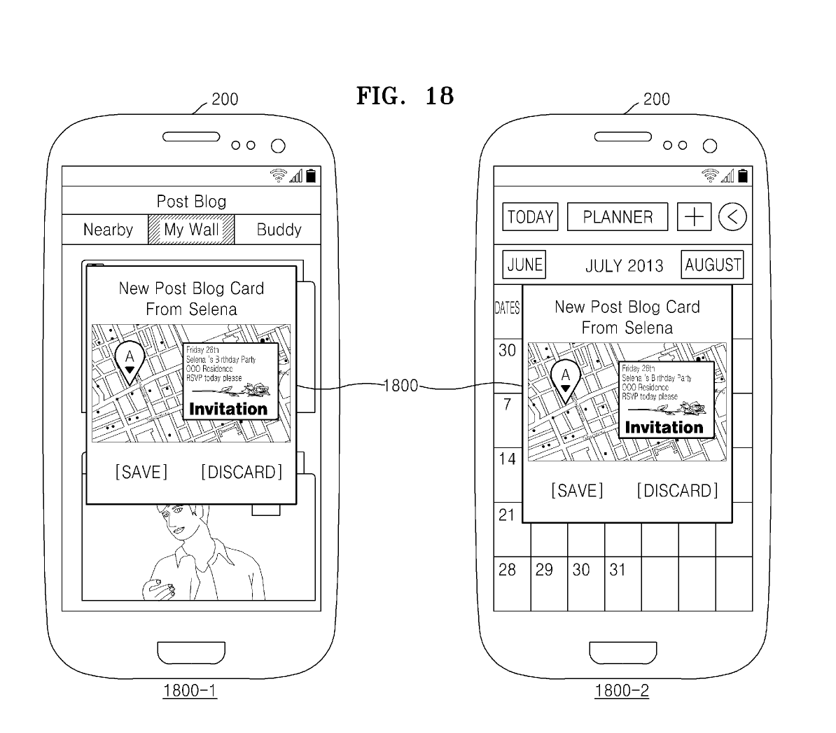

FIG. 18 illustrates an example in which the external device 200 that has the same schedule information as the electronic device 100 displays a first image card received from the electronic device 100, according to an exemplary embodiment. In the exemplary embodiment of FIG. 18, the external device 200 may be one of devices of friends AA, BB, CC, and DD who are supposed to attend Selena's birthday party. Here, it is assumed that the external device 200 corresponds to the device of the friend AA.

As illustrated in 1800-1, when the external device 200 executes an application (e.g., a post blog application) that provides an image card sharing service, according to a request by the friend AA, the external device 200 may display an alarm window 1800 on an execution window of the application so as to notify the friend AA that a first image card 1600 is received from Selena.

As illustrated in 1800-2, when the external device 200 executes a schedule management application (e.g., a calendar application), according to a request by the friend AA, the external device 200 may display the alarm window 1800 on an execution window of the schedule management application so as to notify the friend AA that the first image card 1600 is received from Selena. When the friend AA selects a ‘SAVE’ item from the alarm window 1800, the external device 200 may add and display the first image card 1600 on a schedule table or a calendar.

FIG. 19 is a flowchart of a method of displaying a recommended image card, the method performed by the electronic device 100, according to an exemplary embodiment.

In operation S1910, the electronic device 100 may receive an image card recommendation request. For example, the electronic device 100 may receive a user input that corresponds to the image card recommendation request. The user input that corresponds to the image card recommendation request may vary. The user input may include at least one of a key input, a touch input, a motion input, a bending input, a voice input, and a multimodal input. For example, a user of the electronic device 100 may touch a recommend button displayed on a screen, and thus may input a recommendation request for an image card that is generated by the external device 200.

The image card recommendation request may include not only a request that is consciously performed by the user but also may include a request that is unconsciously performed by the user. For example, when the user performs a first image card generating request (e.g., a selection of a Pick button), the electronic device 100 may determine that the electronic device 100 also receives a recommendation request for an image card that is generated by the external device 200.

In operation S1920, the electronic device 100 may transmit the image card recommendation request to the server 300. The image card recommendation request may include at least one of attribute information about a first image card and context information. The attribute information about the first image card may include metadata about at least one image included in the first image card. For example, the attribute information about the first image card may include, but is not limited to, information about a location at which the at least one image is collected, collecting time information, title information, information about an object included in the at least one image, artist information, content provider information, category information, or the like.

The context information may include, but is not limited to, location information about the electronic device 100 when the electronic device 100 transmits the image card recommendation request, temperature information, humidity information, weather information, season information, illuminance information, noise information, user's status information, user's schedule information, etc.

For example, the electronic device 100 may transmit, to the server 300, an image card recommendation request for requesting an image card of a friend who has similar schedule information of the user. Also, the electronic device 100 may transmit, to the server 300, a recommendation request for requesting a friend's image card that includes an image obtained at the same location at which the at least one image in the first image card is collected. The electronic device 100 may transmit, to the server 300, a recommendation request for requesting an image card that is generated by the external device 200 located within a predetermined distance from a current location (of the electronic device 100.

In operation S1930, the server 300 may select a recommended image card, based on at least one of the attribute information about the first image card, and the context information.

The server 300 may select, as the recommended image card, a second image card that has similar attribute information as the first image card. For example, if images that were collected during a winter trip to Japan are included in the first image card, the server 300 may select, as the recommended image card, a friend AA's image card that includes images that were collected during a winter trip to Japan.

Also, when the user selects a Pick button while the user listens to AA music by using the electronic device 100, the electronic device 100 may generate a first image card including an image of the AA music and may transmit an image card recommendation request to the server 300. Here, the server 300 may select, as the recommended image card, a friend BB's image card that includes an image of the AA music.

The server 300 may select the recommended image card, based on the context information that is collected by the electronic device 100. For example, the server 300 may select external devices located within a predetermined distance from the electronic device 100, and may select image cards that are generated by the selected external devices, as a recommended image card. Also, when the server 300 receives context information about rainy weather from the electronic device 100, the server 300 may select an image card including rain-associated images, as a recommended image card.

The server 300 may select a recommended image card, taking into consideration the attribute information about the first image card and the context information. For example, when images included in the first image card are about food that is served in an AA restaurant, and a current season is Winter, the server 300 may select, as the recommended image card, a friend CC's image card including images about recommended food that is served by the AA restaurant in a winter season.

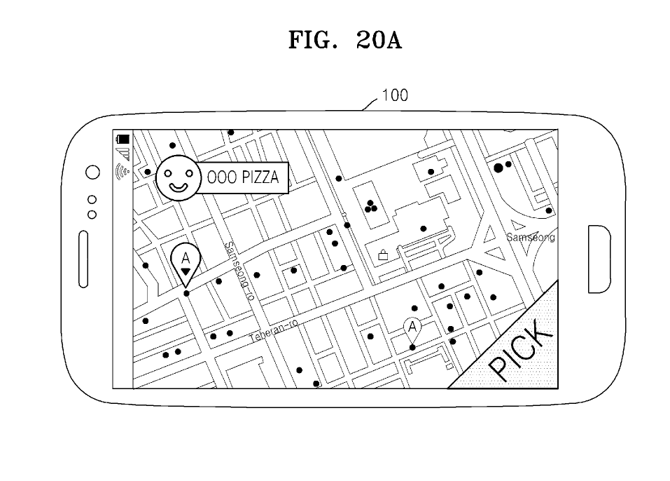

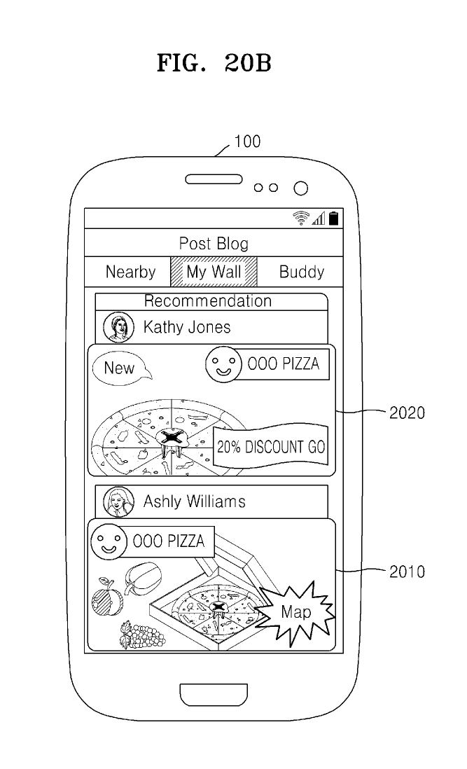

In operation S1940, the server 300 may transmit the recommended image card to the electronic device 100. In operation S1950, the electronic device 100 may receive and display the recommended image card on the screen. Hereinafter, with reference to FIGS. 20A, 20B, 21, and 22, an example in which the electronic device 100 displays the recommended image card will be described in detail.

FIGS. 20A and 20B illustrate an example in which the electronic device 100 co-displays a first image card generated by the electronic device 100, and a recommended image card, according to an exemplary embodiment.

As illustrated in FIG. 20A, the electronic device 100 may execute a map application, may search a location of ‘OOO pizza’ input by a user, and then may display the location on a map. Here, the electronic device 100 may receive an image card generating request or an image collecting request (e.g., selection of a Pick button) from the user.

The electronic device 100 may obtain at least one image associated with map content that is displayed on a screen. For example, the electronic device 100 may collect a map image showing the location of ‘OOO pizza’, a trademark image of ‘OOO pizza’, an image of a pizza served by ‘OOO pizza’, or the like. The electronic device 100 may apply the map image showing the location of ‘OOO pizza’, the trademark image of ‘OOO pizza’, the image of a pizza served by ‘OOO pizza’, or the like to a preset template, and thus may generate a first image card 2010.

The electronic device 100 may transmit, to the server 300, an image card recommendation request that includes the first image card 2010 and attribute information (e.g., information about ‘OOO pizza’) about the first image card 2010.

The server 300 may select a recommended image card, based on the attribute information about the first image card 2010. For example, the server 300 may select, as the recommended image card, a friend DD's image card 2020 that includes a coupon image provided by ‘OOO pizza’. Then, the server 300 may transmit the selected friend DD's image card 2020 to the electronic device 100.

As illustrated in FIG. 20B, the electronic device 100 may display the first image card 2010 including link information (e.g., a map) indicating the location of ‘OOO pizza’, the trademark image of ‘OOO pizza’, the image of the pizza served by ‘OOO pizza’, etc. on the screen. Also, the electronic device 100 may display, as the recommended image card, the friend DD's image card 2020 that includes the coupon image provided by ‘OOO pizza’.

According to the present exemplary embodiment, the user may generate an image card with respect to a user's point of current interest, and may check an image card of a user's friend who has an interest with respect to the same point.

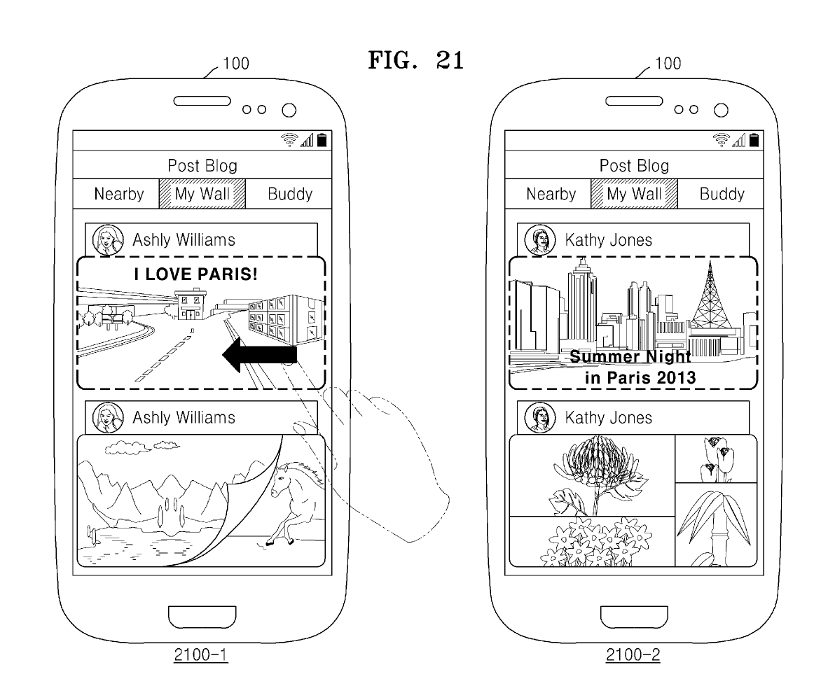

FIG. 21 illustrates an example in which the electronic device 100 recommends an image card of another person, based on a generation location of the image card, according to an exemplary embodiment.

As illustrated in 2100-1, when a user (e.g., Ashly) selects a ‘My Wall’ menu, the electronic device 100 may display, on a screen, a list of first image cards that are generated in response to a request by the user (e.g., Ashly). Here, when the user (e.g., Ashly) inputs a gesture with respect to a first image card 2110 including an image captured during a trip to Paris (e.g., to touch a first image card 2110 displayed in a first area and then to drag it in a second direction while keeping the touching motion), the electronic device 100 may transmit an image card recommendation request that includes attribute information (e.g., collection place: Paris) about the first image card 2110 to the server 300.

According to the image card recommendation request, the server 300 may select a second image card 2120 of a friend (e.g., Kathy) which includes images that were collected in Paris, as the recommended image card. Then, the server 300 may transmit information about a Kathy's blog on which the second image card 2120 of the friend (e.g., Kathy) is posted, to the electronic device 100.

As illustrated in 2100-2, the electronic device 100 may display Kathy's blog including the second image card 2120 having a similar attribute as the first image card 2110, on the screen.

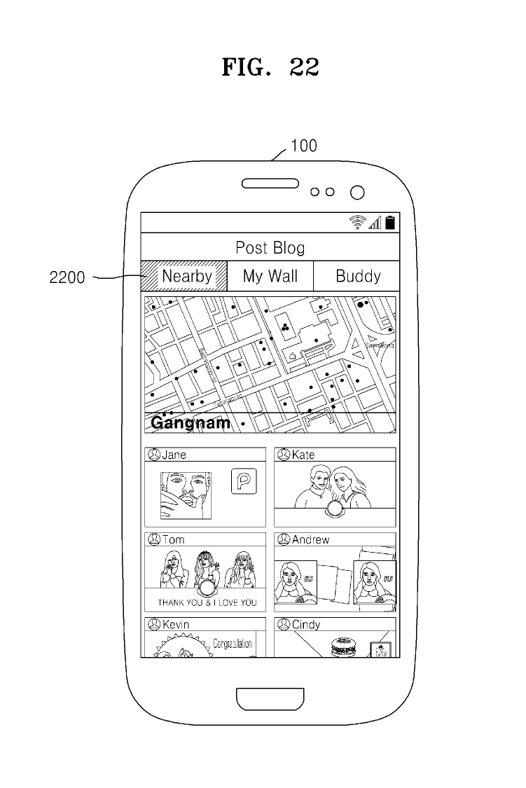

FIG. 22 illustrates an example of a list of second image cards that are generated by external devices, respectively, that are located within a predetermined distance from the electronic device 100, according to an exemplary embodiment.

As illustrated in FIG. 22, when a user selects a ‘Nearby’ menu, the electronic device 100 may transmit an image card recommendation request including location information (e.g., an area ‘Gangnam’) of the electronic device 100 to the server 300.

The server 300 may select second image cards that are generated by external devices, respectively, that are located within a predetermined distance (e.g., 5m) from a location (e.g., the area ‘Gangnam’) of the electronic device 100, as a recommended image card. The predetermined distance may be set and changed by the user, the electronic device 100, or the server 300.

The electronic device 100 may receive, from the server 300, the second image cards that are generated by the external devices, respectively, that are located within the predetermined distance from the electronic device 100. The electronic device 100 may display the list of the second image cards that are generated by the external devices, respectively, on the screen.

For example, if Jane's device, Tom's device, Kevin's device, Kate's device, Andrew's device, and Cindy's device are located within the predetermined distance (e.g. 5M) from the electronic device 100, the electronic device 100 may display Jane's image card, Tom's image card, Kevin's image card, Kate's image card, Andrew's image card, and Cindy's image card on the screen.

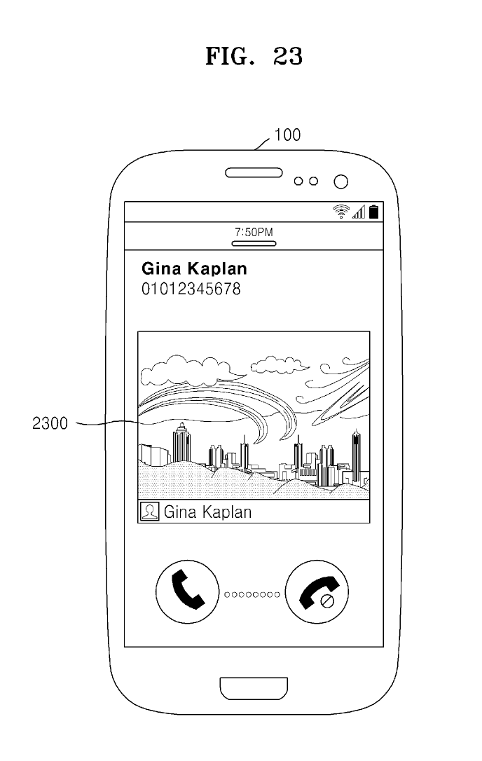

FIG. 23 illustrates an incoming call receiving screen on which a second image card is displayed, according to an exemplary embodiment.

The electronic device 100 may receive an incoming call request from the external device 200. In this case, the electronic device 100 may display a second image card that corresponds to the external device 200 on the incoming call receiving screen.

For example, when an incoming call is received from Gina's device, the electronic device 100 may display an image card 2300 generated by Gina's device, on the incoming call receiving screen. Thus, a user of the electronic device 100 may recognize a current status or recent conditions of a caller (e.g., Gina) before starting a call.

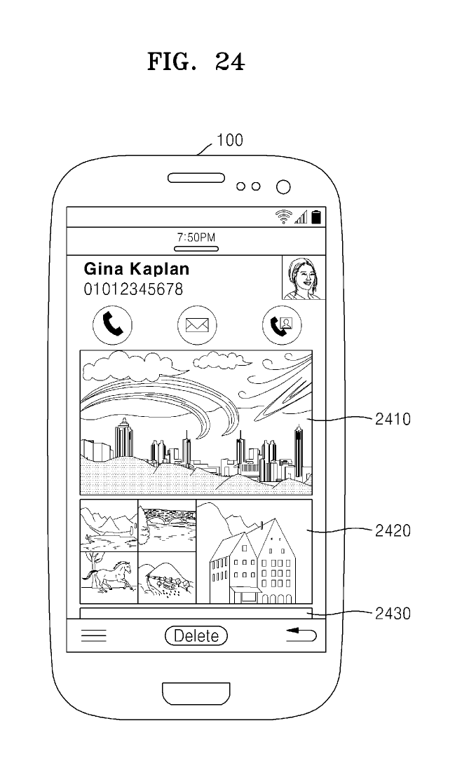

FIG. 24 illustrates an example in which a second image card is displayed on a phone book, according to an exemplary embodiment.

When a second image card is received from the external device 200, the electronic device 100 may add the second image card to user profile information that corresponds to the external device 200. Then, the electronic device 100 may display the user profile information including the second image card.

For example, when second image cards 2410, 2420, and 2430 are received from Gina's device, the electronic device 100 may add the second image cards 2410, 2420, and 2430 to Gina's profile information.

Then, when a user selects Gina from the phone book, the electronic device 100 may co-display Gina's profile information and the second image cards 2410, 2420, and 2430 that are received from Gina's device.

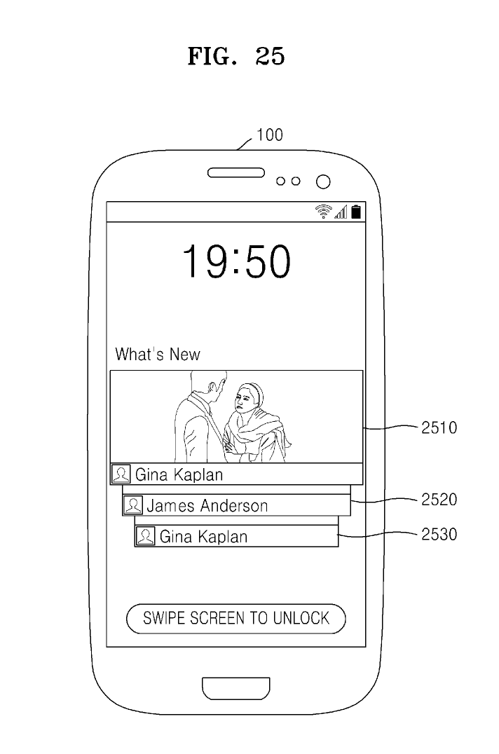

FIG. 25 illustrates an example in which a second image card is displayed on a lock screen, according to an exemplary embodiment.

The electronic device 100 may receive the second image card, which is received from the external device 200, on the lock screen. For example, when the electronic device 100 in a standby mode (e.g., in a block screen status) receives second image cards 2510, 2520, and 2530 that are updated in the external device 200, the electronic device 100 may display the second image cards 2510, 2520, and 2530 that are received during the standby mode, on the lock screen.

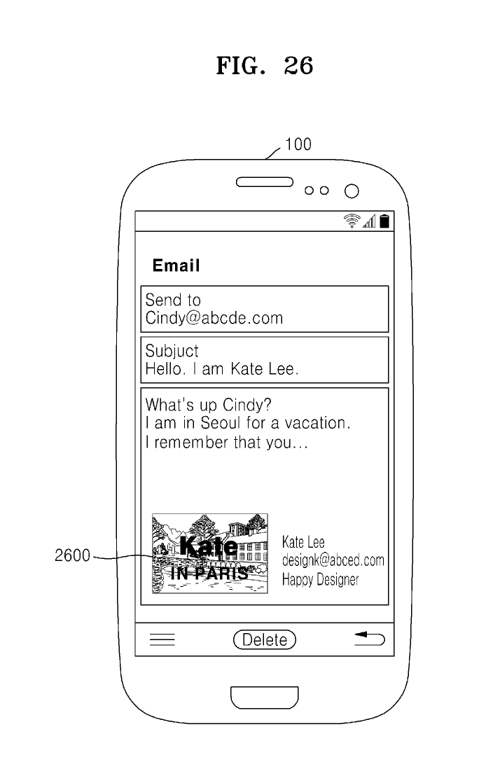

FIG. 26 illustrates an example in which a first image card is used as a signature for an email, according to an exemplary embodiment.

When a user (e.g., Cindy) writes an email, the electronic device 100 may automatically attach a first image card 2600 that has been recently generated by the electronic device 100, as a signature of the user (e.g., Cindy). Then, the email having the first image card 2600 inserted therein as the signature of the user (e.g., Cindy) may be transmitted to a device of a friend (e.g., Kate).

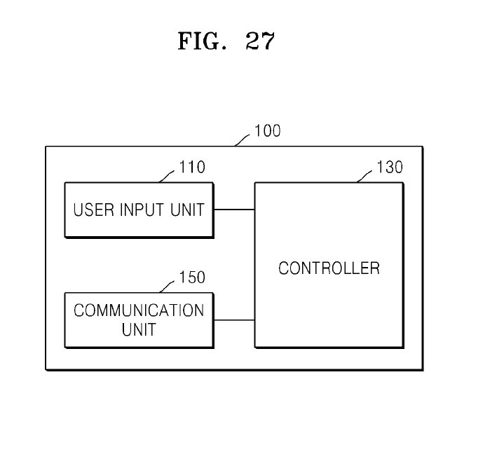

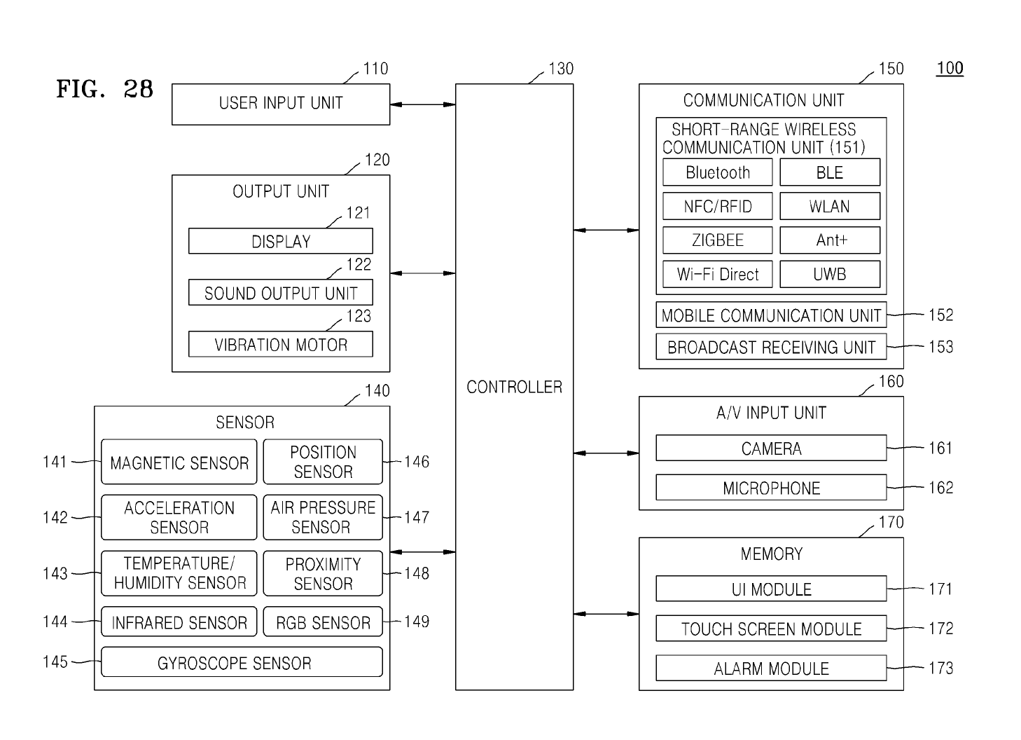

FIGS. 27 and 28 are block diagrams of the electronic device 100, according to exemplary embodiments.

As illustrated in FIG. 27, the electronic device 100 may include a user input unit 110, a controller 130 (also, referred to as a processor 130), and a communication unit 150. However, not all shown elements are necessary elements. That is, the electronic device 100 may be embodied with more or less elements than the shown elements.

For example, as illustrated in FIG. 28, the electronic device 100 may further include an output unit 120, a sensing unit 140, an audio/video (A/V) input unit 160, and a memory 170, as well as the user input unit 110, the controller 130, and the communication unit 150.

Hereinafter, the elements will be described.

The user input unit 110 may be a unit by which a user inputs data so as to control the electronic device 100. For example, the user input unit 110 may include a key pad, a dome switch, a touch pad (a touch capacitive type touch pad, a pressure resistive type touch pad, an infrared beam sensing type touch pad, a surface acoustic wave type touch pad, an integral strain gauge type touch pad, a piezo effect type touch pad, or the like), a jog wheel, and a jog switch, but one or more exemplary embodiments are not limited thereto.

The user input unit 110 may receive a user input. For example, the user input unit 110 may receive the user input of selecting a preset button that corresponds to an image collecting request or an image card generating request.

The user input unit 100 may receive an input of selecting, as a first image card, an image card from a list of image cards that correspond to templates. The user input unit 100 may receive an input of a text associated with the first image card. Also, the user input unit 100 may receive an image card recommendation request.

The output unit 120 may function to output an audio signal, a video signal, or a vibration signal and may include a display unit 121, a sound output unit 122, a vibration motor 123, or the like.

The display unit 121 displays and outputs information that is processed in the electronic device 100. For example, the display unit 121 may display a first image card generated by the electronic device 100, a second image card generated by the external device 200, or the like.

The display unit 121 may display a list of first image cards or a list of second image cards. The display unit 121 may display a list of second image cards that are generated by external devices, respectively.

The display unit 121 may array the list of the second image cards, based on information about reception times at which the second image cards were received, respectively. The display unit 121 may array the recently-received second image cards at a top of the list.

The display unit 121 may display user profile information including the second image card. The display unit 121 may display, on a lock screen, the second image card that is received from the external device 200. According to an incoming call request from the external device 200, the electronic device 100 may display the second image card on a call reception screen. The display unit 121 may add the second image card to at least one of a photo album, a diary, a calendar, a map, a content reproduction list, and a phone address book that are provided by the electronic device 100 and then may display the second image card.

When the display unit 121 and a touch pad form a mutual layer structure and then are formed as a touch screen, the display unit 121 may be used as both an output device and input device. The display unit 121 may include at least one of a liquid crystal display (LCD), a thin film transistor-liquid crystal display (TFT-LCD), an organic light-emitting diode (OLED) display, a flexible display, a 3D display, and an electrophoretic display. Also, according to a type of the electronic device 100, the electronic device 100 may include at least two display units 121. Here, the at least two display units 121 may face each other by using a hinge.

The sound output unit 122 may output audio data that is received from the communication unit 150 or is stored in the memory 170. The sound output unit 122 may also output a sound signal (e.g., a call signal receiving sound, a message receiving sound, a notifying sound, or the like) related to capabilities performed by the electronic device 100. The sound output unit 122 may include a speaker, a buzzer, or the like.

The vibration motor 123 may output a vibration signal. For example, the vibration motor 123 may output the vibration signal that corresponds to an output of the audio data (e.g., the call signal receiving sound, the message receiving sound, or the like) or video data. Also, when a touch is input to the touch screen, the vibration motor 123 may output a vibration signal.

The controller 130 may generally control all operations of the electronic device 100. That is, the controller 130 may control the user input unit 110, the output unit 120, the sensing unit 140, the communication unit 150, the A/V input unit 160, etc. by executing programs stored in the memory 170.

The controller 130 may obtain at least one image associated with content that is provided by the electronic device 100, according to a user input. For example the controller 130 may obtain metadata about the content, and may search for the at least one image associated with the content by using the metadata. The controller 130 may generate a first image card including the obtained at least one image, based on preset template information.

The controller 130 may obtain context information according to a user input, and may obtain at least one image associated with the content, in consideration of the context information. The controller 130 may generate image cards by using templates that are included in the preset template information.

The controller 130 may insert link information associated with the content into the first image card. The controller 130 may add a text that is input by the user into the first image card. The controller 130 may add the second image card into the user profile information that corresponds to the external device 200.

The sensing unit 140 may sense a status of the electronic device 100 or a status around the electronic device 100, and may deliver information about the sensed status to the controller 130.

The sensing unit 140 may include at least one of a magnetic sensor 141, an acceleration sensor 142, a temperature/humidity sensor 143, an infrared sensor 144, a gyroscope sensor 145, a position sensor (e.g., GPS) 146, an air pressure sensor 147, a proximity sensor 148, and an RGB sensor (i.e., a luminance sensor) 149, but one or more exemplary embodiments are not limited thereto. Functions of the sensors may be intuitionally deduced by one of ordinary skill in the art by referring to names of the sensors, thus, detailed descriptions thereof are omitted here.

The communication unit 150 may include one or more elements allowing communication between the electronic device 100 and the external device 200 or between the electronic device 100 and the server 300. For example, the communication unit 150 may include a short-range wireless communication unit 151, a mobile communication unit 152, and a broadcast receiving unit 153.

The short-range wireless communication unit 151 may include, but is not limited to, a Bluetooth communication unit, a Bluetooth Low Energy (BLE) communication unit, a Near Field Communication (NFC) unit, a WLAN (Wi-Fi) communication unit, a ZigBee communication unit, an infrared Data Association (IrDA) communication unit, a Wi-Fi Direct (WFD) communication unit, an ultra wideband (UWB) communication unit, or an Ant+ communication unit.

The mobile communication unit 152 exchanges a wireless signal with at least one of a base station, an external terminal, and a server on a mobile communication network. The wireless signal may include various types of data according to communication of a sound call signal, a video call signal, or a text/multimedia message.

The broadcast receiving unit 153 receives a broadcast signal and/or information related to a broadcast from the outside through a broadcast channel. The broadcast channel may include a satellite channel and a ground wave channel. According to an exemplary embodiment, the electronic device 100 may not include the broadcast receiving unit 153.

The communication unit 150 may share the first image card with the external device 200. For example, the communication unit 150 may transmit the first image card to the external device 200. Here, the communication unit 150 may transmit the first image card to the external device 200 via the server 300, or may directly transmit the first image card to the external device 200.

The communication unit 150 may receive the second image card generated by the external device 200. Here, the communication unit 150 may receive the second image card from the external device 200 via the server 300 or may directly receive the second image card from the external device 200.

The communication unit 150 may transmit, to the server 300, an image card recommendation request including at least one of attribute information about the first image card, and context information obtained by the electronic device 100 according to the user input. The communication unit 150 may receive, from the server 300, a second image card that is selected as a recommended image card based on at least one of the attribute information about the first image card, and the context information.

The communication unit 150 may transmit, to the server 300, an image card recommendation request that includes location information about the electronic device 100. Based on the location information about the electronic device 100, the communication unit 150 may receive, from the server 300, second image cards that are generated by external devices, respectively, that are located within a predetermined distance from the electronic device 100.

The communication unit 150 may receive an incoming call request from the external device 200.

The A/V input unit 160 may receive an input of an audio signal or a video signal and may include a camera 161 and a microphone 162. The camera 161 may obtain an image frame such as a still image or a video via an image sensor during a video call mode or an image-capturing mode. An image that is captured via the image sensor may be processed by the controller 130 or a separate image processing unit.

The image frame that is processed by the camera 161 may be stored in the memory 170 or may be transmitted to an external source via the communication unit 150. According to a configuration of the device 100, two or more cameras 161 may be arranged.

The microphone 162 receives an external sound signal as an input and processes the received sound signal into electrical voice data. For example, the microphone 162 may receive a sound signal from an external device or a speaker. In order to remove noise that occurs while the sound signal is externally input, the microphone 162 may use various noise removing algorithms.

The memory 170 may store a program for processing and controlling the controller 130, or may store a plurality of pieces of input/output data (e.g., menus, first layer sub-menus that correspond to the menus, respectively, second layer sub-menus that correspond to the first layer sub-menus, respectively, etc.).

The memory 170 may include a storage medium of at least one type of a flash memory, a hard disk, a multimedia card type memory, a card type memory such as an SD or XD card memory, RAM, SRAM, ROM, EEPROM, PROM, a magnetic memory, a magnetic disc, and an optical disc. Also, the electronic device 100 may run web storage or a cloud server that performs a storage function of the memory 170 on the Internet.

The programs stored in the memory 170 may be classified into a plurality of modules according to their functions, for example, into a UI module 171, a touch screen module 172, an alarm module 173, etc.

The UI module 171 may provide a specialized UI or GUI in connection with the electronic device 100 for each application. The touch screen module 172 may detect a user's touch gesture on the touch screen and transmit information related to the touch gesture to the controller 130. The touch screen module 172 may recognize and analyze a touch code. The touch screen module 172 may be configured by additional hardware including a controller.

Various sensors may be arranged in or near the touch screen so as to detect a touch or a proximate touch on the touch sensor. An example of the sensor to detect the touch on the touch screen may include a tactile sensor. The tactile sensor detects a contact of a specific object at least as sensitively as a person can detect. The tactile sensor may detect various types of information such as the roughness of a contact surface, the hardness of the contact object, the temperature of a contact point, or the like.

An example of the sensor to detect the touch on the touch screen may include a proximity sensor.

The proximity sensor detects the existence of an object that approaches a predetermined detection surface or that exists nearby, by using a force of an electro-magnetic field or an infrared ray, instead of a mechanical contact. Examples of the proximity sensor include a transmission-type photoelectric sensor, a direction reflection-type photoelectric sensor, a mirror reflection-type photoelectric sensor, a high frequency oscillation-type proximity sensor, a capacity-type proximity sensor, a magnetic proximity sensor, an infrared-type proximity sensor, or the like. The touch gesture (i.e., an input) of the user may include a tap gesture, a touch & hold gesture, a double tap gesture, a drag gesture, a panning gesture, a flick gesture, a drag & drop gesture, a swipe gesture, or the like.

The alarm module 173 may generate a signal for notifying the user about an occurrence of an event in the electronic device 100. Examples of the event that may occur in the electronic device 100 include a call signal receiving event, a message receiving event, a key signal input event, a schedule notifying event, or the like. The alarm module 173 may output an alarm signal in the form of a video signal via the display unit 121, an alarm signal in the form of an audio signal via the sound output unit 122, or an alarm signal in the form of a vibration signal via the vibration motor 123.

One or more exemplary embodiments may also be embodied as programmed commands to be executed in various computer units, and then may be recorded in a computer-readable recording medium. The computer-readable recording medium may include one or more of the programmed commands, data files, data structures, or the like. The programmed commands recorded to the computer-readable recording medium may be particularly designed or configured for one or more exemplary embodiments or may be well known to one of ordinary skill in the art. Examples of the computer-readable recording medium include magnetic media including hard disks, magnetic tapes, and floppy disks, optical media including CD-ROMs and DVDs, magneto-optical media including floptical disks, and hardware designed to store and execute the programmed commands in ROM, RAM, a flash memory, and the like. Examples of the programmed commands include not only machine code generated by a compiler but also include a high-level programming language to be executed in a computer by using an interpreter.

According to the exemplary embodiments, the electronic device 100 generates an image card that represents a status of a user, and facilitates user interaction for sharing the image card. Accordingly, the user, by using the electronic device 100, may generate the image card that represents the status of the user and may share the image card with friends via the simple user interaction.

It should be understood that the exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A method of sharing an image card with an external device performed by an electronic device, the method comprising:
receiving, at the electronic device, a user input;
obtaining at least one image associated with content that is provided by the electronic device, according to the user input;
generating a first image card comprising the at least one image, based on preset template information; and
sharing the first image card to the external device.

2. The method of claim 1, wherein the receiving the user input comprises:
receiving a selection of a preset button that corresponds to at least one of an image collecting request and an image card generating request.

3. The method of claim 1, wherein the obtaining the at least one image comprises:
obtaining metadata about the content; and
searching for the at least one image associated with the content, by using the metadata.

4. The method of claim 1, wherein the obtaining the at least one image comprises:
obtaining context information in response to receiving the user input; and
obtaining the at least one image associated with the content, based on the context information.

5. The method of claim 4, wherein the context information comprises at least one of location information about the electronic device, status information about a user of the electronic device, environment information within a predetermined distance from the electronic device, and user schedule information.

6. The method of claim 1, wherein the preset template information comprises at least one of layout information, theme information, text design information, and information about an effect filter that transforms an image into a different form.

7. The method of claim 1, wherein the generating the first image card comprises:
generating image cards by using templates comprised in the preset template information;
displaying a list of the image cards; and
receiving an input selecting one image card from the list, as the first image card.

8. The method of claim 1, wherein the generating the first image card comprises:
inserting link information related to the content into the first image card.

9. The method of claim 1, wherein the sharing the first image card comprises:
receiving an input of a text related to the first image card;
adding the text to the first image card; and
sharing the first image card having the added text to the external device.

10. The method of claim 1, further comprising displaying, on a screen, a list of first image cards comprising the first image card and one or more first image cards that were previously generated.

11. The method of claim 1, further comprising:
receiving a second image card generated by the external device; and
displaying the second image card.

12. The method of claim 11, wherein the receiving the second image card comprises:
transmitting, to a server, an image card recommendation request comprising at least one of attribute information about the first image card and context information that is obtained by the electronic device according to the user input; and
receiving, from the server, the second image card that is selected as a recommended image card based on at least one of the attribute information about the first image card and the context information.

13. The method of claim 11, wherein the receiving the second image card comprises:
transmitting, to a server, an image card recommendation request comprising location information about the electronic device; and
receiving, from the server and based on the location information about the electronic device, second image cards that are generated by external devices, respectively, that are located within a predetermined distance from the electronic device, and
wherein the displaying the second image card comprises displaying, on a screen, a list of the second image cards that are generated by the external devices.

14. The method of claim 11, wherein the receiving the second image card comprises: receiving second image cards generated by the external device, and
wherein the displaying of the second image card comprises: displaying, on a screen, a list of the second image cards based on information about reception times at which the second image cards were received.

15. The method of claim 11, wherein the displaying the second image card comprises:
adding the second image card to user profile information that corresponds to the external device; and
displaying the user profile information comprising the second image card.

16. The method of claim 11, wherein the displaying the second image card comprises: displaying the second image card on a lock screen.

17. The method of claim 11, wherein the displaying the second image card comprises:
receiving an incoming call request from the external device; and
displaying the second image card on an incoming call receiving screen, according to the incoming call request.

18. The method of claim 11, wherein the displaying the second image card comprises:
adding the second image card to at least one of a photo album, a diary, a calendar, a map, a content reproduction list, and a phone address book that are provided by the electronic device, and
displaying the second image card.

19. An electronic device comprising:
a user input unit configured to receive a user input;
a controller configured to obtain at least one image associated with content that is provided by the electronic device, according to the user input, and generate a first image card comprising the at least one image, based on preset template information; and
a communication unit configured to share the first image card to an external device.

20. The electronic device of claim 19, wherein the user input comprises selection a preset button that corresponds to at least one of an image collecting request and an image card generating request.

21. The electronic device of claim 19, wherein the controller is further configured to obtain metadata about the content, and search for the at least one image associated with the content, based on the metadata.

22. The electronic device of claim 19, wherein the controller is further configured to obtain context information in response to receiving the user input, and obtain the at least one image associated with the content, based on the context information.

23. The electronic device of claim 19, wherein the controller is further configured to generate image cards by using templates comprised in the preset template information, and display a list of the image cards, and
wherein the user input unit is further configured to receive an input selecting one image card from the list, as the first image card.

24. The electronic device of claim 19, wherein the controller is further configured to insert link information related to the content into the first image card.

25. The electronic device of claim 19, wherein the user input unit is further configured to receive an input of a text related to the first image card,
wherein the controller is further configured to add the text to the first image card, and
wherein the communication unit is further configured to share the first image card having the text added thereto to the external device.

26. The electronic device of claim 19, further comprising a display unit configured to display, on a screen, a list of first image cards comprising the first image card and one or more first image cards that were previously generated.

27. The electronic device of claim 19, wherein the communication unit is further configured to receive a second image card generated by the external device, and
wherein the electronic device further comprises a display unit configured to display the second image card.

28. The electronic device of claim 27, wherein the communication unit is further configured to transmit, to a server, an image card recommendation request comprising at least one of attribute information about the first image card and context information that is obtained by the electronic device according to the user input, and receive, from the server, the second image card that is selected as a recommended image card based on at least one of the attribute information about the first image card and the context information.

29. The electronic device of claim 27, wherein the communication unit is further configured to transmit, to a server, an image card recommendation request comprising location information about the electronic device, and receive, from the server and based on the location information about the electronic device, second image cards that are generated by external devices, respectively, that are located within a predetermined distance from the electronic device, and
wherein the display unit is further configured to display, on a screen, a list of the second image cards that are generated by the external devices.

30. The electronic device of claim 27, wherein the communication unit is further configured to receive second image cards generated by the external device, and
wherein the display unit is further configured to display, on a screen, a list of the second image cards based on information about reception times at which the second image cards were received.

31. The electronic device of claim 27, wherein the controller is further configured to add the second image card to user profile information that corresponds to the external device, and
wherein the display unit is further configured to display the user profile information comprising the second image card.

32. The electronic device of claim 27, wherein the display unit is further configured to display the second image card on a lock screen.

33. The electronic device of claim 27, wherein the communication unit is further configured to receive an incoming call request from the external device, and
wherein the display unit is further configured to display the second image card on an incoming call receiving screen, according to the incoming call request.

34. The electronic device of claim 27, wherein the display unit is further configured to add the second image card to at least one of a photo album, a diary, a calendar, a map, a content reproduction list, and a phone address book that are provided by the electronic device, and display the second image card.

35. A non-transitory computer-readable recording medium having recorded thereon a program that is executable by a computer to perform the method of claim 1.

36. A method of generating and sharing an image card, the method comprising:
receiving, at an electronic device, an image associated with content that is provided by the electronic device;
generating a first image card based on the at least one image and preset template information; and
sharing the first image card to an external device.

37. The method of claim 36, further comprising:
receiving metadata about the content and context information,
wherein the generating the first image card is further based on at least one of the metadata and the context information.

38. An electronic device for generating and sharing an image card comprising:
an input unit configured to receive an image associated with content that is provided by the electronic device;
a controller configured to generate a first image card based on the at least one image and preset template information; and
a communication unit configured to transmit the first image card to an external device.

39. The electronic device of claim 38,
wherein the input unit is further configured to receive metadata about the content and context information, and
wherein the controller is further configured to generate the first image card based further on at least one of the metadata and the context information.
